(19) United States
(12) Patent Application Publication
(10) Pub. No.: US 2016/0300499 A1
(43) Pub. Date: Oct. 13, 2016

(54) Flashcard System

(71) Applicant: ADP, LLC, Roseland, NJ (US)

(72) Inventors: Nick Heasman, New York, NY (US); Min Wang, New York, NY (US)

(21) Appl. No.: 14/682,611

(22) Filed: Apr. 9, 2015

(51) Int. Cl. G09B 5/10; G09B 5/02

(52) U.S. Cl. CPC G09B 5/10; G09B 5/02

(57) ABSTRACT

A method for graphically displaying data within a flashcard system that facilitates a networking connection of an employee. A computer system identifies a meeting the employee is scheduled to attend. The computer system then identifies the social interest of the employee. Based on the social interest, the computer system identifies a contact for the employee who is also attending the meeting. The computer system generates a group of flashcards for relevant attributes about the contact. The relevant attributes about the contractor associated with the social interest. The computer system displays the group of flashcards for the relevant attributes about the contact. Displaying the group of flashcards about the social interest enables communication between the employee and the contact at the meeting, thereby facilitating the network connection between the employee and contact.

### BACKGROUND INFORMATION

1. Field

The present disclosure relates generally to an improved data processing system. In particular, the present disclosure relates to a method and apparatus for managing the training of employees in an organization. Still more particularly, the present disclosure relates to a method and apparatus for a graphical user interface used to train employees of an organization utilizing flashcard display system.

2. Background

Information systems are used for many different purposes. For example, an information system also may be used to facilitate human learning processes. A corporation may facilitate human learning processes to achieve a specific business purpose by helping a user review, learn, or memorize information programs and organizations using a flashcard system.

Flashcards, both analog and digital, are in common use as a method to help a user review, learn and/or memorize information in small pieces. Likewise, flashcards may be used to test a user's knowledge of a subject in small visualized increments. However, current flashcards tend to fall into two categories. One category includes material and information that is permanent or changes very slowly over time such as math facts, presidents of the United States, elements of the periodic table, and the like. Another category includes flashcards related to different topics that are manually created by a user or group of users for private or public use. In both cases the content of the flashcards is static after creation. As related data becomes available or the data changes there is no automatic way to update the flashcards in order to visually present new information. Additionally, the presentation of the cards may be completely random or related to user's mastery of a subject where the presentation of a flashcard may decrease after the user demonstrates user mastery of the flashcard content.

Therefore, it would be desirable to have a method and apparatus that take into account at least some of the issues discussed above, as well as other possible issues. For example, it would be desirable to have a flashcard system enables achievement of a specific business purpose by dynamically updating and presenting relevant flashcard content.

### SUMMARY

In one illustrative embodiment, a method for graphically displaying data within a flashcard system that facilitates a networking connection of an employee is presented. The computer system identifies a meeting the employee is scheduled to attend. The computer system then identifies the social interest of the employee. Based on the social interest, the computer system identifies a contact for the employee who is also attending the meeting. The computer system generates a group of flashcards for relevant attributes about the contact. The relevant attributes about the contractor associated with the social interest. The computer system displays the group of flashcards for the relevant attributes about the contact. Displaying the group of flashcards about the social interest enables communication between the employee and the contact at the meeting, thereby facilitating the network connection between the employee and contact.

In another illustrative embodiment, a graphical display system comprises a computer system and a flashcard system that facilitates a networking connection of an employee in communication with the display system. The computer system identifies a meeting the employee is scheduled to attend. The computer system then identifies the social interest of the employee. Based on the social interest, the computer system identifies a contact for the employee who is also attending the meeting. The computer system generates a group of flashcards for relevant attributes about the contact. The relevant attributes about the contractor associated with the social interest. The computer system displays the group of flashcards for the relevant attributes about the contact on a graphical user interface of the display system. Displaying the group of flashcards about the social interest enables communication between the employee and the contact at the meeting, thereby facilitating the network connection between the employee and contact.

In another illustrative embodiment, a computer program product for graphically displaying data within a flashcard system that facilitates a networking connection of an employee comprises a computer readable storage media, and program code stored on the computer readable storage media is presented. The program code instructs the flashcard system to identify a meeting the employee is scheduled to attend. The program code instructs the flashcard system to identify a social interest of the employee. Based on the social interest, the program code instructs the flashcard system to identify the contact for the employee who is also attending the meeting. The program code instructs the flashcard system to generate a group of flashcards for relevant attributes about the contact. The relevant attributes about the contractor associated with the social interest. The program code instructs the flashcard system to display the group of flashcards for the relevant attributes about the contact. Displaying the group of flashcards about the social interest enables communication between the employee and the contact at the meeting, thereby facilitating the network connection between the employee and contact.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a flashcard environment depicted in accordance with an illustrative embodiment;

FIG. 2A is an illustration of a graphical user interface for interaction with a flashcard system depicted in accordance with an illustrative embodiment;

FIG. 2B is an illustration of a graphical user interface for interaction with a flashcard system depicted in accordance with an illustrative embodiment;

FIG. 3A is an illustration of a graphical user interface for specifying a particular data set in a flashcard system depicted in accordance with an illustrative embodiment;

FIG. 3B is an illustration of a graphical user interface for generating flashcards based on a selection of a particular data set in a flashcard system depicted in accordance with an illustrative embodiment;

FIG. 3C is an illustration of a graphical user interface for generating flashcards based on a selection of a relevant attribute within selected data set in a flashcard system depicted in accordance with an illustrative embodiment;

FIG. 3D is an illustration of a graphical user interface for generating flashcards based on a selection of a second relevant attribute within selected data set in a flashcard system depicted in accordance with an illustrative embodiment;

FIG. 4 is an illustration of a graphical user interface for interacting with flashcards based on a selection of a second relevant attribute within selected data set of a flashcard system depicted in accordance with an illustrative embodiment;

FIG. 5A is an illustration of a graphical user interface for providing feedback after a selection of a correct response regarding relevant attribute response to a single flashcards in a flashcard system depicted in accordance with an illustrative embodiment;

FIG. 5B is an illustration of a graphical user interface for providing feedback after a selection of an erroneous response regarding relevant attribute response to a single flashcards in a flashcard system depicted in accordance with an illustrative embodiment;

FIG. 6A is an illustration of a graphical user interface for providing feedback regarding response to multiple flashcards in a flashcard system depicted in accordance with an illustrative embodiment;

FIG. 6B is an illustration of a graphical user interface for providing feedback regarding response to multiple flashcards in a flashcard system depicted in accordance with an illustrative embodiment;

FIG. 7 is an illustration of a graphical user interface for displaying overall performance of individuals in this a flashcard system depicted in accordance with an illustrative embodiment;

FIG. 8A is an illustration of a graphical user interface for selecting data sets and relevant attributes for review in this a flashcard system depicted in accordance with an illustrative embodiment;

FIG. 8B is an illustration of a graphical user interface for displaying flashcards for review in a flashcard system depicted in accordance with an illustrative embodiment;

FIG. 9 is an illustration of a block diagram of a modified flashcard environment to facilitate the attainment of a specific business objective depicted in accordance with an illustrative embodiment;

FIG. 10 is an illustration of a flowchart of a process for generating a set of flashcards depicted in accordance with an illustrative embodiment;

FIG. 11 is an illustration of a flowchart of a process for evaluating user performance for flashcards as depicted in accordance with an illustrative embodiment;

FIG. 12 is an illustration of a flowchart of a process for generating a set of flashcards for achieving an objective of preparing employees for a meeting, conference or event depicted in accordance with an illustrative embodiment;

FIG. 13 is an illustration of a flowchart of a process for generating a set of flashcards for achieving an objective of facilitating a business-centric networking connection for an employee depicted in accordance with an illustrative embodiment;

FIG. 14 is an illustration of a flowchart of a process for generating the set of flashcards for achieving an objective of training employees within a retail environment depicted in accordance with an illustrative embodiment;

FIG. 15 is an illustration of a flowchart of a process for generating the set of flashcards for achieving the objectives of training employees within a law-enforcement environment depicted in accordance with an illustrative embodiment; and

FIG. 16 is an illustration of a block diagram of a data processing system depicted in accordance with an illustrative embodiment.

### DETAILED DESCRIPTION

The illustrative embodiments recognize and take into account one or more different considerations. For example, the illustrative embodiments recognize and take into account that commonly used digital flashcards and analog flashcards lack the capability to automatically update flashcards in order to visually present new information for situationally relevant topics. Furthermore, the different illustrative embodiments recognize and take into account that current systems and methods of facilitating networking contacts in a dynamically changing environment may be limited in various ways. The illustrative embodiments implement and integrate a flashcard system into a business networking setting in a manner that takes into account the dynamic nature of business networking events, and adapt the display of flashcards content based on situationally relevant topics.

For example, the illustrative embodiments recognize and take into account that presenting contextually relevant information in flashcard system may be more difficult than desired. Commonly used digital flashcards and analog flashcards lack the capability to automatically update flashcards in order to visually present new information for situationally relevant topics. Furthermore, The illustrative embodiments recognize and take into account that facilitating networking connection in the business environment may be more difficult than desired.

Thus, the illustrative embodiments provide a method and apparatus for graphically displaying data within a flashcard system that facilitates a networking connection of an employee. In one example, a process for graphically displaying data within a flashcard system that facilitates networking connection of an employee is presented. A computer system identifies a meeting the employee is scheduled to attend. The computer system then identifies the social interest of the employee. Based on the social interest, the computer system identifies a contact for the employee who is also attending the meeting. The computer system generates a group of flashcards for relevant attributes about the contact. The relevant attributes about the contractor associated with the social interest. The computer system displays the group of flashcards for the relevant attributes about the contact. Displaying the group of flashcards about the social interest enables communication between the employee and the contact at the meeting, thereby facilitating the network connection between the employee and contact.

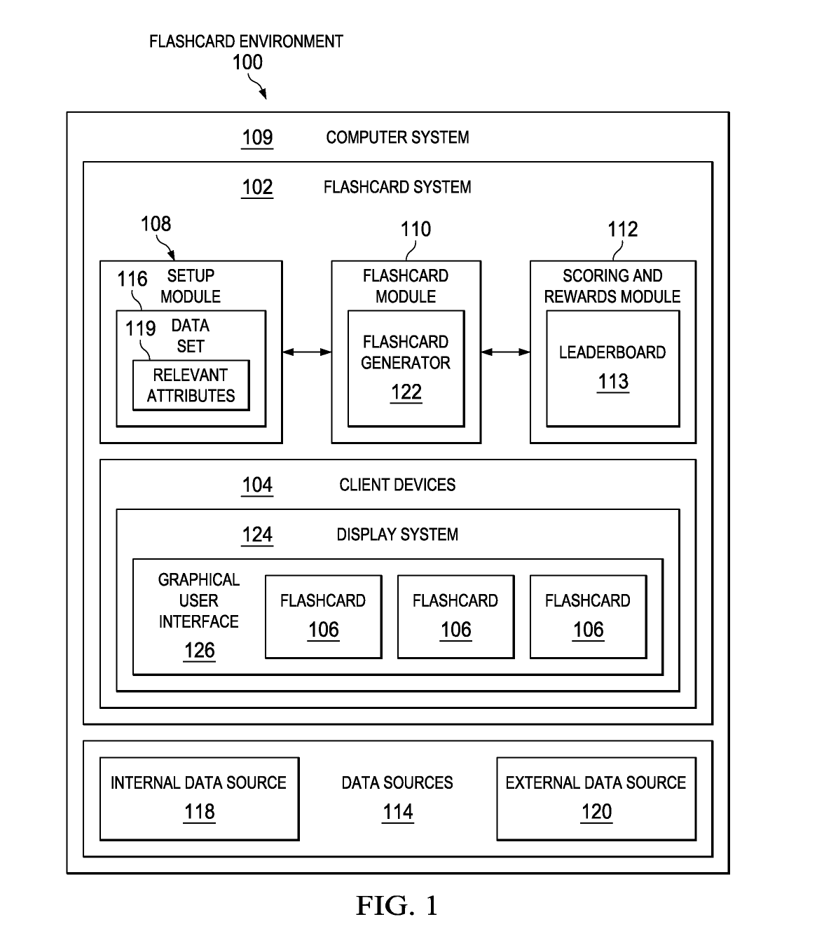

With reference now to the Figures and in particular with reference to FIG. 1, an illustration of a block diagram of a flashcard environment is depicted in accordance with an illustrative embodiment. Flashcard environment 100 includes flashcard system 102. Flashcard system 102 is used to perform operations with respect to client device 104. The operations can be, for example but not limited to, at least one of generating, monitoring, and evaluating client interaction with flashcards 106. Flashcard system 102 and generally includes setup module 108, flashcard module 110, and Scoring and Rewards module 112.

Flashcard system 102 can be implemented in computer system 109, where the computer system is a hardware system includes one or more data processing systems. When more than one data processing system is present, those data processing systems may be in communication with each other using a communications medium. The communications medium may be a network. The data processing systems may be selected from at least one of a computer, a workstation, a server computer, a tablet computer, a laptop computer, a mobile phone, a personal digital assistant (PDA), or some other suitable data processing system.

Setup module 108 enables specifying relevant data attributes and or indicated information to be included in flashcards 106. Setup module 108 integrates data gathered from data sources 114 into data set 116. Data set 116 is data integrated by setup module 108 from data sources 114 for use by flashcard module 110. Setup module 108 facilitates the user in identifying a plurality of relevant attributes 119 from data set 116 to be included as part of the learning review process. In an illustrative embodiment, setup module 108 may facilitate a user in identifying specific fields within data set 116 to be reviewed. Similarly, a user may specify a topic, and setup module 108 may identify relevant fields from data set 116 according to a rule set.

Flashcard module 110 facilitates providing portions of the relevant data to the user or other destination. Flashcard module 110 may also have an interaction capability to facilitate specifying information.

Flashcard module 110 includes flashcards generator 122. Flashcards generator 122 generates flashcards 106 from data set 116 based on relevant attributes 119 therein.

Flashcards generator 122 may be implemented in software, hardware, firmware or a combination thereof. When software is used, the operations performed by flashcards generator 122 may be implemented in program code configured to run on hardware, such as a processor unit. When firmware is used, the operations performed by flashcards generator 122 may be implemented in program code and data and stored in persistent memory to run on a processor unit. When hardware is employed, the hardware may include circuits that operate to perform the operations in flashcards generator 122.

In the illustrative examples, the hardware may take the form of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

Scoring and Rewards module 112 may track the performance of individual users as well as tracking the performance of groups of individual users. Overall performance of individuals may be tracked. Overall success rate with certain flashcards or groups of flashcards may be tracked. Successful performance, such as by answering a number of flashcards correctly, may be associated with rewards for individuals, groups of individuals, and the like. The reward may be an accumulation of points, cash reward, public acknowledgment on a leaderboard, and the like.

Flashcard system 102 is in communication with data sources 114. Data sources 114 can include at least one of internal data source 118 and external data source 120. Internal data source 118 and external data source 120 can be a structured data source, or unstructured data source from which the information used in flashcards 106 is gathered. Setup module 108 extract relevant attributes from data sources 114. Setup module 108 stores the relevant attributes 119 within data set 116 for use by flashcard module 110 in generating flashcards 106.

As used herein, the phrase “at least one of,” when used with a list of items, means different combinations of one or more of the listed items may be used and only one of each item in the list may be needed. In other words, at least one of means any combination of items and number of items may be used from the list but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Internal data source 118 are databases local to the user, local to a company or local to an enterprise. Databases local to the user can be, for example but not limited to, a user's personal address book and a user's calendar. Databases local to a company or an enterprise can be, for example but not limited to, a human resources database and a company directory. Internal data source 118 can be, for example, a database implemented in a common computer system as flashcard system 102.

External data source 120 can be external databases open to the public over a network, such as the Internet. External data source 120 can include external databases such as for example but not limited to, databases of an educational institution and databases of a technical society, such as technical society publications. External data source 120 can include data collected from at least one of social media sites and informational sites. Social media sites can be, for example but not limited to, LinkedIn and Facebook. Information site can be, for example but not limited to, Wikipedia.

Relevant attributes 119 may include images, such as images of people, products, locations, flora and fauna. Relevant attributes may include demographic or personal information such as an image of a person, the name, title, interest, family and friends, related projects, locations, start date for the company, associates and colleagues, skills, accomplishments and the like. Relevant attributes 119 may include detailed information on a company's products and services such as images, specifications, applications, target markets, sales data, competitors, market data and the like. Relevant attributes 119 may include information about any branch of learning from art history to geography and white. Relevant attributes 119 may include timelines, geographic details, and the like. Relevant attributes may have in different temporal components were some of the data has little or no variability, such as a person's birthday, education, and other data is transitory such as a person's latest social media comments, current projects, and the like. Relevant attributes 119 may have some location sensitive data over location information and people may be weighted more strongly in the selection flashcards.

Relevant attributes accessible for review may be limited based on user login, department, role in light. Relevant attributes accessible through the may be based on previous performance with flashcards. A user may need to successfully master a given set of facts before being given access to additional information any tiered learning approach.

Flashcard system 102 includes client device 104. Client device 104 is one or more data processing systems on which a user can interact with flashcard 106. The client device 104 can be, for example but not limited to, a mobile device, such as smart telephones, tablets, notebooks, mobile computers, portable devices, wearable displays, and the like.

As depicted, client device 104 includes display system 124. In this illustrative example, display system 124 can be a group of display devices. A display device in display system 124 may be selected from one of a liquid crystal display (LCD), a light emitting diode (LED) display, an organic light emitting diode (OLED) display, and other suitable types of display devices.

In this illustrative example, display system 124 includes graphical user interface 126. Graphical user interface 126 is an interface that allows users to interact with client device 104 through manipulation of graphical icons and visual indicators depicted flashcard 106. In this illustrative example, flashcard system 102 can display flashcard 106, or other suitable information in graphical user interface 126.

Flashcards 106 are displayed on display system 124. Flashcards 106 are data objects that expose small increments of information at a time allowing the user to review, learn, and memorize information in small pieces. Flashcards 106 may be used to test a user's knowledge of a subject in small increments. By exposing and testing on small increments of knowledge, flashcards 106 facilitates customization of instruction and testing based on a user's existing knowledge and learning curve. As a user master certain material or concepts, the appearance of information in flashcards 106 may be reduced. Material with which the user struggles with an emphasized more strongly or appear more frequently in flashcards 106 until the user demonstrates mastery.

An illustrative embodiment, flashcard module 110 may allow the user to interact with flashcards 106 in various ways. For example, flashcards 106 may also have an inner action capability. By providing interaction, flashcards 106 facilitates specifying information for the flashcards, such as through fill in the blank, multiple-choice, recommendations, and the like.

As a result, computer system 109 operates as a special purpose computer system in which flashcards generator 122 in computer system 109 enables a customized learning, review, and, evaluation to be performed as part of a flashcard system based on data gathered from disparate sources. Flashcards generator 122 relevant information based on identified business goals and creates flashcards for the systematic learning and memorization of the relevant information to aid in achievement of the identified business goals.

Flashcard system 102 enables a personalized approach to learning, review, and, evaluation of the relevant information to aid in achievement of the identified business goals. Thus, flashcards generator 122 transforms computer system 109 into a special purpose computer system as compared to currently available general computer systems that do not have flashcards generator 122.

The illustration of flashcard system 102 in FIG. 1 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

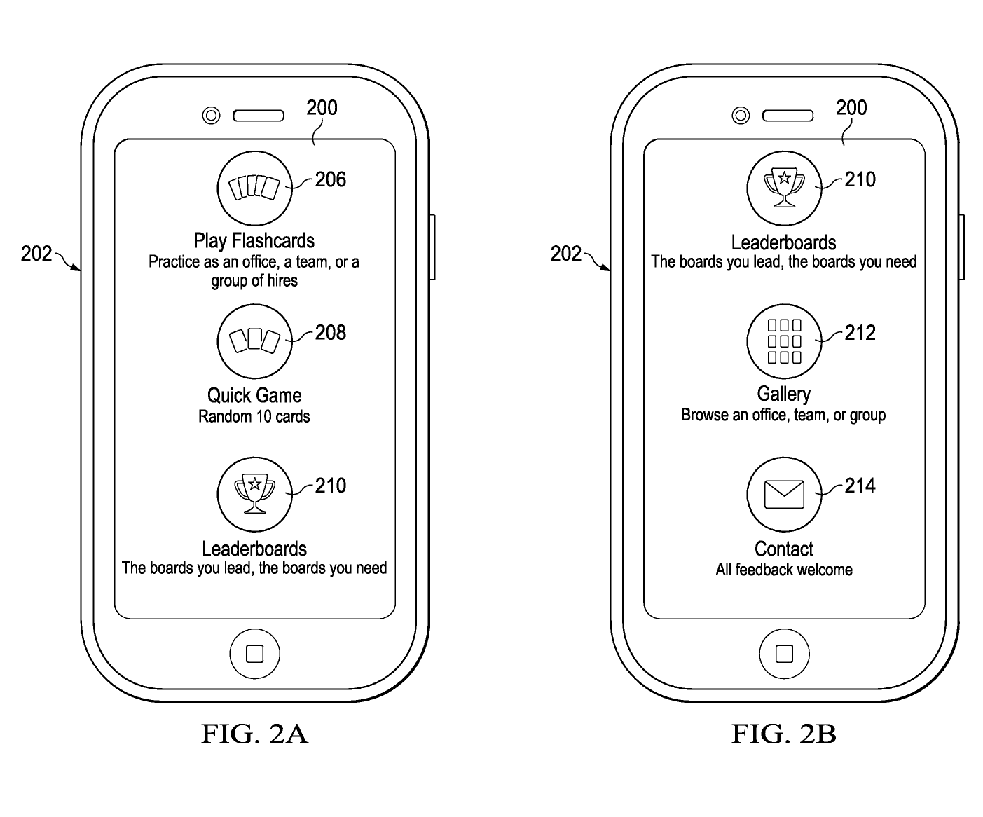

With reference next to FIGS. 2A and 2B, an illustration of a graphical user interface for interaction with a flashcard system is depicted in accordance with an illustrative embodiment. As depicted, graphical user interface 200 is an example of a graphical user interface 126 in FIG. 1. As depicted, graphical user interface 200 is displayed on mobile device 202. Mobile device 202 is an example of client devices 104 in FIG. 1. As depicted, a user can toggle between FIGS. 2A and 2B by interacting with graphical user interface 200, such as by scrolling.

Referring specifically to FIG. 2A, graphical user interface 200 is depicted displaying icon 206, icon 208, and icon 210. Each of icon 206, icon 208, and icon 210 is a graphical image displayed on within graphical user interface 200 that enables a user to order to interact with flashcards 106 as displayed on mobile device 202.

As depicted, icon 206 is labeled “Play Flashcards.” By selecting icon 206, a user may be given a choice of data sets to review. The data set can be data set 116 of FIG. 1. Upon selecting icon 206, a user may further be given a choice as to relevant attributes within the selected data set. The relevant attributes can be relevant attributes 119 at FIG. 1. For example, a user may be given a choice of relevant attributes to review such as at least one of location, team, start date and the like. Once the data set has been specified, a user may be shown in an image and given multiple-choice response selections for the correct answer.

As depicted, icon 208 is labeled “Quick Game.” According to an illustrative embodiment, when icon 208 is selected, flashcard system 102 of FIG. 1 can randomly generate a number of flashcards 106 of FIG. 1 without requiring specification of data sets were relevant attributes from the user.

Alternatively, according to an illustrative embodiment, when icon 208 is selected, flashcard system 102 can generate a number of flashcards 106 based on a previously specified user preference. The user preference can specify, for example but not limited to a most recently reviewed data set, most recently reviewed relevant attributes, a data set indicated as having a requisite proficiency level, relevant attributes indicated as having a requisite proficiency level, a data set indicated as not having a requisite proficiency level, and relevant attributes indicated as not having a requisite proficiency level.

Alternatively, according to an illustrative embodiment, when icon 208 is selected, flashcard system 102 can generate a number of flashcards 106 based on predefined sequence in which flashcards 106 are to be presented. The predefined sequence can be, for example, a progression of flashcards 106 that logically progresses through a particular topic, such as a particular one of data sets 116 or relevant attributes 119, to facilitate rapid learning of the topic.

Alternatively, according to an illustrative embodiment, when icon 208 is selected, flashcard system 102 can generate a number of flashcards 106 to emphasize recent changes or additions to data sets 116 or relevant attributes 119.

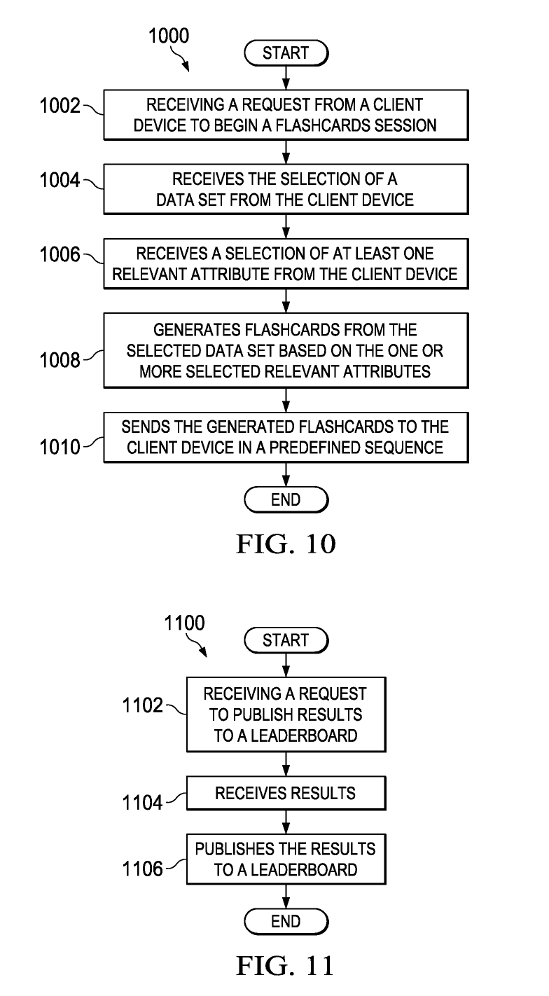

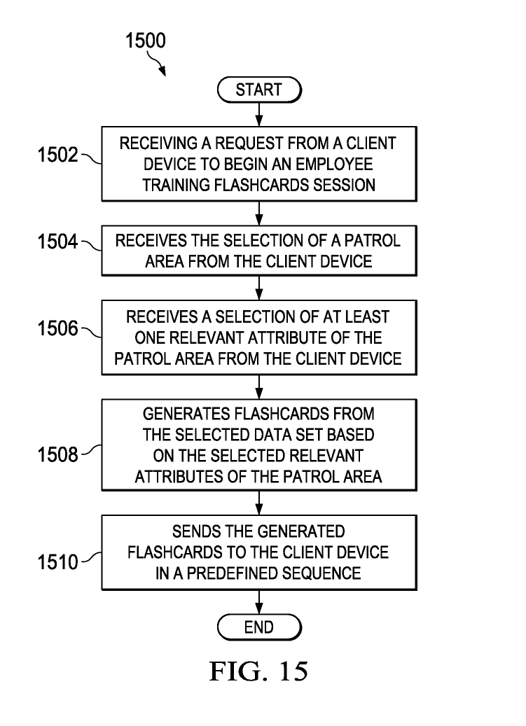

As depicted, icon 210 labels, “Leaderboards.” In addition to being provided with feedback on their relative answer to a single flashcards has seen in FIGS. 10-11, the user may be provided with feedback on their overall performance on a set of flashcards. Depending on user performance, they may be given the option of posting their score to a leaderboard shown in FIG. 15. The report can be, for example leaderboard 113 of FIG. 1. When icon 210 is selected, graphical user interface 200 can display a leaderboard, including a current ranking of users for a particular one of data sets 116 or relevant attributes 119, as shown in FIG. 15.

Referring specifically to FIG. 2B, graphical user interface 200 is depicted displaying icon 210, icon 212, and icon 214. Each of icon 210, icon 212, and icon 214 is a graphical image displayed on within graphical user interface 200 that enables a user to order to interact with flashcards 106 as displayed on mobile device 202.

As depicted, icon 212 is labeled, “Gallery.” When icon 208 is selected, a user may be given a choice of data sets to review. The data set can be data set 116 FIG. 1. Upon selecting icon 206, a user may further be given a choice as to relevant attributes within the selected data set. Flashcard system 102 can generate a number of flashcards 106 based on predefined sequence that logically progresses through a new topic, such as a particular one of data sets 116 or relevant attributes 119, to facilitate rapid learning of the new topic.

As depicted, icon 214 is labeled, “Contact.” When icon 214 is selected, the user may be given an option to provide feedback. The feedback can include, for example but not limited to feedback for a particular one of data sets 116 or relevant attributes 119. In an illustrative embodiment, flashcard system 102 can use feedback to identify and continuity crowd source data sets 116 or relevant attributes 119.

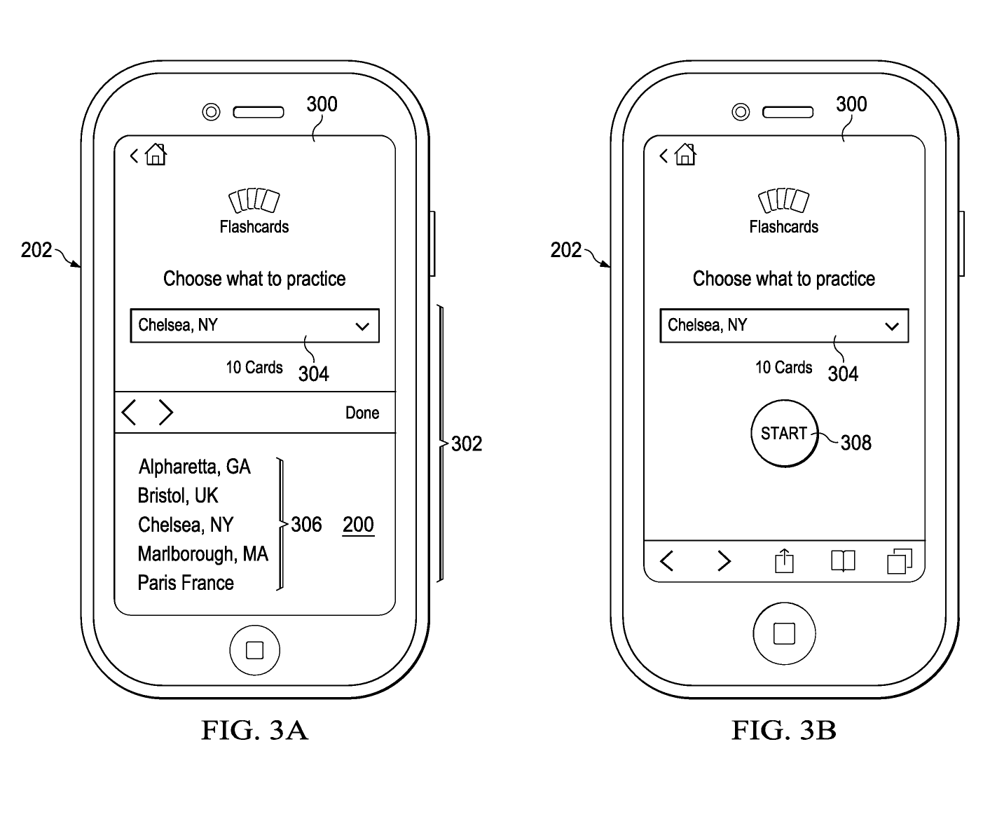

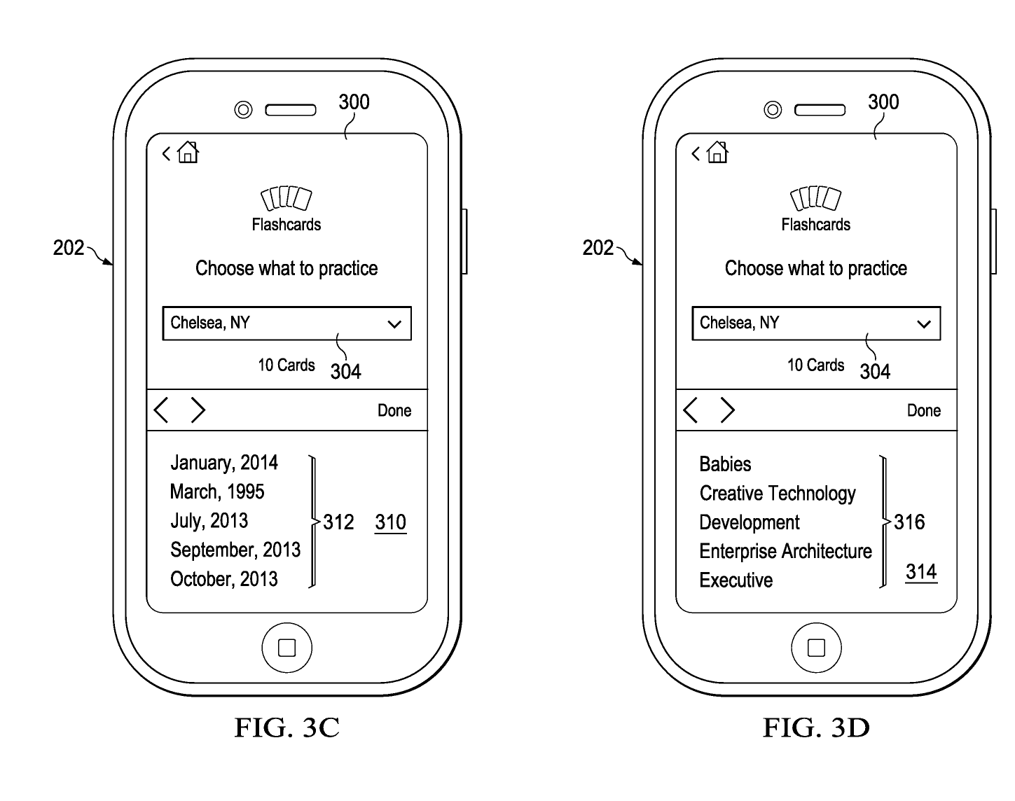

With reference next to FIGS. 3A, 3B, 3C, and 3D, an illustration of a graphical user interface for selecting data sets and relevant attributes in this a flashcard system is depicted in accordance with an illustrative embodiment. As depicted, graphical user interface 300 is graphical user interface 200 FIG. 2 after a selection of icon 206.

As depicted in FIG. 3A, graphical user interface 300 includes menus 302 for specifying a particular one of data sets 116 of FIG. 1 or relevant attributes 119 of FIG. 1 to be used by flashcards generator 122 of FIG. 1 when generating flashcards 106 of FIG. 1. As depicted, menus 302 allow a user to select between locations using drop-down menu 304. By selecting one of location, a user can review flashcards 106, including any employees and relevant attributes thereof, specific to that location. Flashcards generator 122 generates flashcards 106 from one of data sets 116 is specific to the selected location. Any relevant attributes 119 presented in flashcards 106 therefore relate only to the selected location, and not to the plurality of locations in drop-down menu 304 generally.

As depicted, menus 302 include drop-down menu 304 and cycle menu 306. Drop-down menu 304 is a graphical control element, which allows the user to choose a specific location from a list of locations. Cycle menu 306 is a graphical control element, which allows the user to rotate through locations to select a specific location. While not shown, any 302 can include other graphical control elements that allow for user selection, such as but not limited to, or at least one of a button, a slider, a list box, a spinner, a drop-down menu, a menubar, a toolbar, a scrollbar and an icon.

With reference next to FIG. 3B, an illustration of a graphical user interface for generating flashcards based on a selection of a particular data set selecting data set in this a flashcard system is depicted in accordance with an illustrative embodiment. As depicted in FIG. 3B, graphical user interface 300 is graphical user interface 300 of FIG. 3A after a selection of a data set for a specific location from menus 302.

Graphical user interface 300 is depicted displaying icon 308. Icon 308 is a graphical image displayed on within graphical user interface 300 that enables a user to interact with flashcards 106 as displayed on mobile device 202.

As depicted, icon 308 is labeled, “Start.” When icon 308 is selected, notification of a data set selected from menus 302 is sent from mobile device 202 to flashcard system 102. Upon receiving notification, flashcard system 102 can prepare flashcards 106 for the selected data set indicated in menu 302.

With reference next to FIG. 3C, an illustration of a graphical user interface for generating flashcards based on a selection of a relevant attribute within selected data set of a flashcard system is depicted in accordance with an illustrative embodiment. As depicted in FIG. 3C, graphical user interface 300 is graphical user interface 300 of FIG. 3A after a selection of a data set for a specific location from menus 302.

As depicted, graphical user interface 300 includes cycle menu 310. Cycle menu 310 is a graphical control element, which allows the user to rotate through relevant attributes in order to further limit the generation and presentation of flashcards 106. As depicted, cycle menu 310 allows the user to rotate through the relevant attribute start dates 312. By selecting one of start dates 312, a user can review flashcards 106, including any employees and relevant attributes thereof that are associated with the selected one of start dates 312. Flashcards generator 122 generates flashcards 106 from the selected one of data sets 116 that are specific to the selected one of start dates 312. Any relevant attributes 119 presented in flashcards 106 therefore relate only to the selected one of start dates 312, and not generally to the plurality of start dates 312 shown in cycle menu 310.

With reference next to FIG. 3D, an illustration of a graphical user interface for generating flashcards based on a selection of a second relevant attribute within selected data set of a flashcard system is depicted in accordance with an illustrative embodiment. As depicted in FIG. 3D, graphical user interface 300 is graphical user interface 300 of FIG. 3C after a selection of a data set for a specific location from menus 302.

As depicted, graphical user interface 300 includes cycle menu 314. Cycle menu 314 is a graphical control element, which allows the user to rotate through relevant attributes in order to further limit the generation and presentation of flashcards 106. As depicted, cycle menu 314 allows the user to rotate through the relevant attribute of employee teams 316. By selecting one employee teams 316, a user can review flashcards 106, including any employees and relevant attributes thereof that are associated with the selected one of employee teams 316. Flashcards generator 122 generates flashcards 106 from the selected one of data sets 116 that is specific to the selected one of employee teams 316. Any relevant attributes 119 presented in flashcards 106 therefore relate only to the selected one of employee teams 316, and not generally to the plurality of employee teams 316 shown in cycle menu 314.

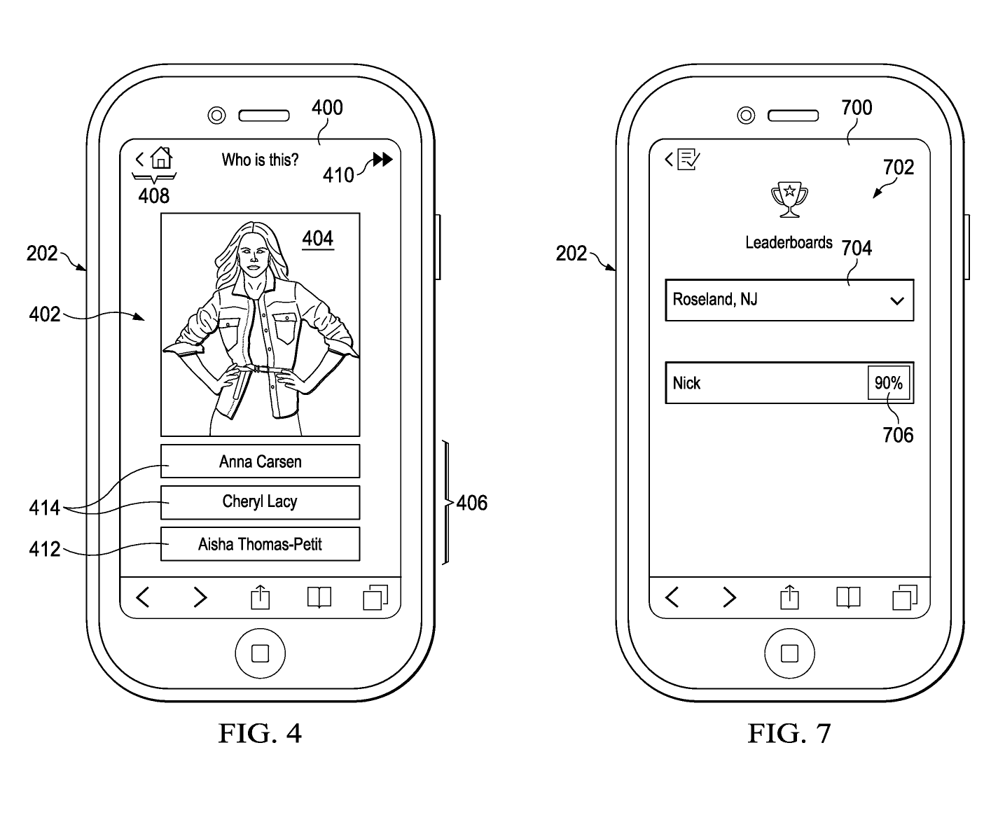

With reference now to FIG. 4, an illustration of a graphical user interface for interacting with flashcards based on a selection of a second relevant attribute within selected data set of a flashcard system is depicted in accordance with an illustrative embodiment. As depicted, graphical user interface 400 is an example of graphical user interface 126 of FIG. 1. According to an illustrative embodiment, graphical user interface 400 is displayed when a user selects a data set 116 and any relevant attributes 119 of FIG. 1 after selecting icon 206 of FIG. 2A. According to an illustrative embodiment, graphical user interface 400 is alternatively displayed when a user selects icon 208 of FIG. 2A.

Graphical user interface 400 displays flashcard 402. Flashcard 402 is an example of flashcards 106 in FIG. 1. As depicted, flashcard 402 includes prompted attribute 404, attribute responses 406, navigation icons 408 and navigation icon 410.

Prompted attribute 404 is one of relevant attributes 119 of FIG. 1, as limited by a user specification such as described in relation to FIGS. 3A-3D. As depicted, prompted attribute 404 is a graphical image displayed on within graphical user interface 400 that elicits a response from the user to facilitate rapid learning of prompted attribute 404.

As depicted, prompted attribute 404 is an image of a person. However, according to an illustrative embodiment, prompted attribute 404 can be any of relevant attributes 119 to facilitate rapid learning. Therefore, while not shown, prompted attribute 404 can include images, such as images of people, products, locations, flora and fauna. Prompted attribute 404 may include demographic or personal information such as an image of a person, the name, title, interest, family and friends, related projects, locations, start date for the company, associates and colleagues, skills, accomplishments and the like. Prompted attribute 404 may include detailed information on a company's products and services such as images, specifications, applications, target markets, sales data, competitors, market data and the like. Prompted attribute 404 may include information about any branch of learning from art history to geography and white. prompted attribute 404 may include timelines, geographic details, and the like. Prompted attribute 404 may have in different temporal components were some of the data has little or no variability, such as a person's birthday, education, and other data is transitory such as a person's latest social media comments, current projects, and the like. prompted attribute 404 may have some location sensitive data over location information and people may be weighted more strongly in the selection flashcards.

Attribute responses 406 are ones of relevant attributes 119, as limited by a user specification such as described in relation to FIGS. 3A-3D. As depicted, attribute responses 406 are graphical images displayed on within graphical user interface 400 that indicate a possible response from the user to facilitate rapid learning of prompted attribute 404.

As depicted, attribute responses 406 are names of a person. However, according to an illustrative embodiment, attribute responses 406 can be any of relevant attributes 119 to facilitate rapid learning of prompted attribute 404. Therefore, while not shown, attribute responses 406 can include images, such as images of people, products, locations, flora and fauna. Attribute responses 406 may include demographic or personal information such as an image of a person, the name, title, interest, family and friends, related projects, locations, start date for the company, associates and colleagues, skills, accomplishments and the like. Attribute responses 406 may include detailed information on a company's products and services such as images, specifications, applications, target markets, sales data, competitors, market data and the like. Attribute responses 406 may include information about any branch of learning from art history to geography and white. Attribute responses 406 may include timelines, geographic details, and the like. Attribute responses 406 may have in different temporal components were some of the data has little or no variability, such as a person's birthday, education, and other data is transitory such as a person's latest social media comments, current projects, and the like. Attribute responses 406 may have some location sensitive data over location information and people may be weighted more strongly in the selection flashcards.

As depicted, attribute responses 406 includes correct response 412, and at least one erroneous response 414. Correct response 412 is one of relevant attributes 119 that is associated with prompted attribute 404. Erroneous response 414 is one of relevant attributes 119 that is not associated with prompted attribute 404. According to an illustrative embodiment, erroneous response 414 is one of relevant attributes 119 that is not associated prompted attribute 404, but rather is associated with a different one of relevant attributes 119.

Navigation icons 408 is a graphical image displayed on within graphical user interface 400 that enables a user to order to interact with flashcards 106 as displayed on mobile device 202. As depicted, navigation icon 408 is failing to return the user to a setup screen without progressing through the remaining flashcards 106.

Navigation icon 410 is a graphical image displayed on within graphical user interface 400 that enables a user to order to interact with flashcards 106 as displayed on mobile device 202. As depicted, navigation icon 410 allows a user to progress to a next one of flashcards 106. According to an illustrative embodiment, a user may progress to the next one of flashcards 106 without first selecting one of attribute responses 406 of flashcard 402.

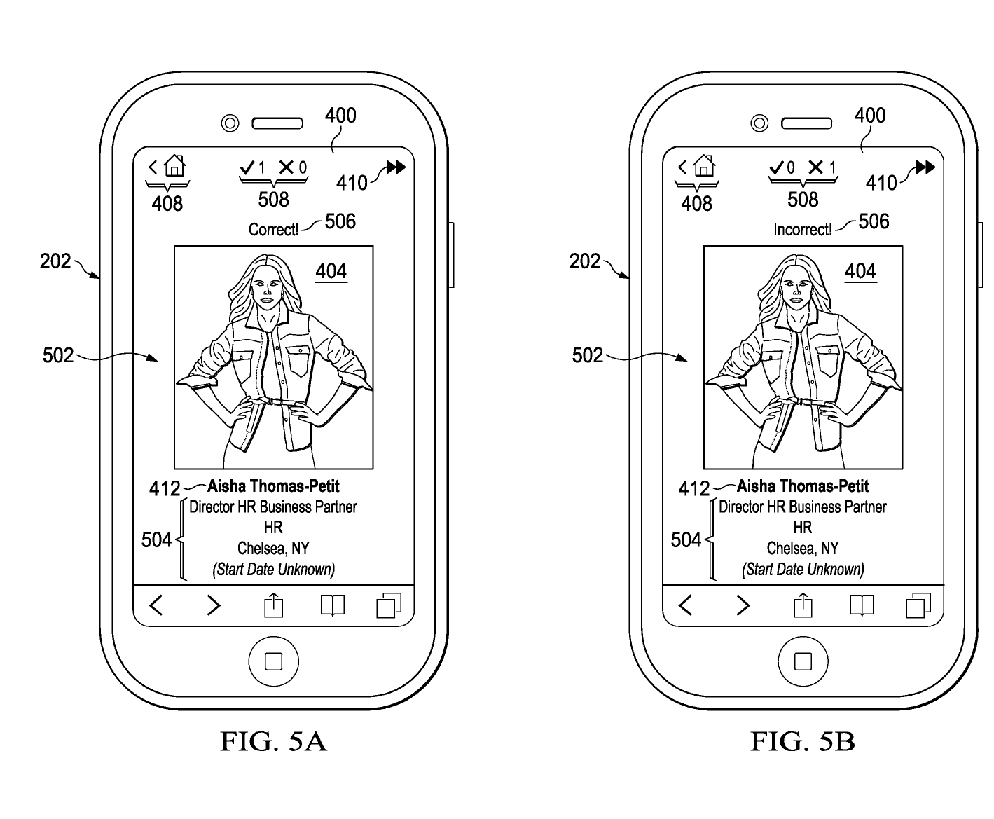

With reference now to FIGS. 5A and 5B, an illustration of a graphical user interface for providing feedback regarding relevant attribute response to a single flashcards in a flashcard system is depicted in accordance with an illustrative embodiment. As depicted, graphical user interface 500 is graphical user interface 400 of FIG. 4 after a selection of one of attribute responses 406 of FIG. 4.

Referring specifically to FIG. 5A, graphical user interface 400 is depicted after a selection of correct response 412 of FIG. 4. As depicted, graphical user interface 500 displays flashcard 502. Flashcard 502 is an example of flashcards 106 in FIG. 1. As depicted, flashcard 502 includes prompted attribute 404, correct response 412, additional attributes 504, validation 506 and tally 508.

As depicted, flashcard 502 presents prompted attribute 404 and correct response 412 and additional attributes 504. By repeating the information prompted attribute 404 and correct response 412, flashcard 502 provides the user with immediate positive feedback, reinforcing the selection of correct response 412 to facilitate rapid learning of both prompted attribute 404 and correct response 412.

Additionally, flashcard 502 presents additional attributes 504. Additional attributes 504 are additional ones of relevant attributes 119 of FIG. 1 that are associated with prompted attribute 404. As depicted, additional attributes 504 are graphical images displayed on within graphical user interface 400 that indicate a position, department, and location of the person depicted in prompted attribute 404 to facilitate rapid learning of prompted attribute 404 as well as additional attributes 504.

As depicted, additional attributes 504 indicate a position, department, and location of a person. However, according to an illustrative embodiment, additional attributes 504 can be any of relevant attributes 119 to facilitate rapid learning. Therefore, while not shown, additional attributes 504 can include images, such as images of people, products, locations, flora and fauna. Additional attributes 504 may include demographic or personal information such as an image of a person, the name, title, interest, family and friends, related projects, locations, start date for the company, associates and colleagues, skills, accomplishments and the like. Additional attributes 504 may include detailed information on a company's products and services such as images, specifications, applications, target markets, sales data, competitors, market data and the like. Additional attributes 504 may include information about any branch of learning from art history to geography and white. Additional attributes 504 may include timelines, geographic details, and the like. additional attributes 504 may have in different temporal components were some of the data has little or no variability, such as a person's birthday, education, and other data is transitory such as a person's latest social media comments, current projects, and the like. Additional attributes 504 may have some location sensitive data over location information and people may be weighted more strongly in the selection flashcards.

As depicted, flashcard 502 includes validation 506 and tally 508. Validation 506 is an indication regarding the correctness of the selection of one of attribute responses 406 of flashcard 402. As depicted, validation 506 indicates that the user has correctly selected correct response 412.

Tally 508 is an indication regarding a current score of the user for each previous flashcards presented in the current flashcards session. As depicted, validation 506 indicates that the user has selected a correct response, such as correct response 412, for one flashcards presented in the current flashcards session. Validation 506 indicates that the user has not selected an erroneous response, such as erroneous response 414, for any of flashcards presented in the current flashcards session.

Referring now to FIG. 5B, graphical user interface 500 is depicted after a selection of an erroneous response 414 of FIG. 4. As depicted, validation 506 indicates that the user has incorrectly selected erroneous response 414. As depicted, validation 506 indicates that the user has not yet selected a correct response, such as correct response 412, for any of the flashcards presented in the current flashcards session. Validation 506 indicates that the user has not selected an erroneous response, such as erroneous response 414, for one flashcards presented in the current flashcards session.

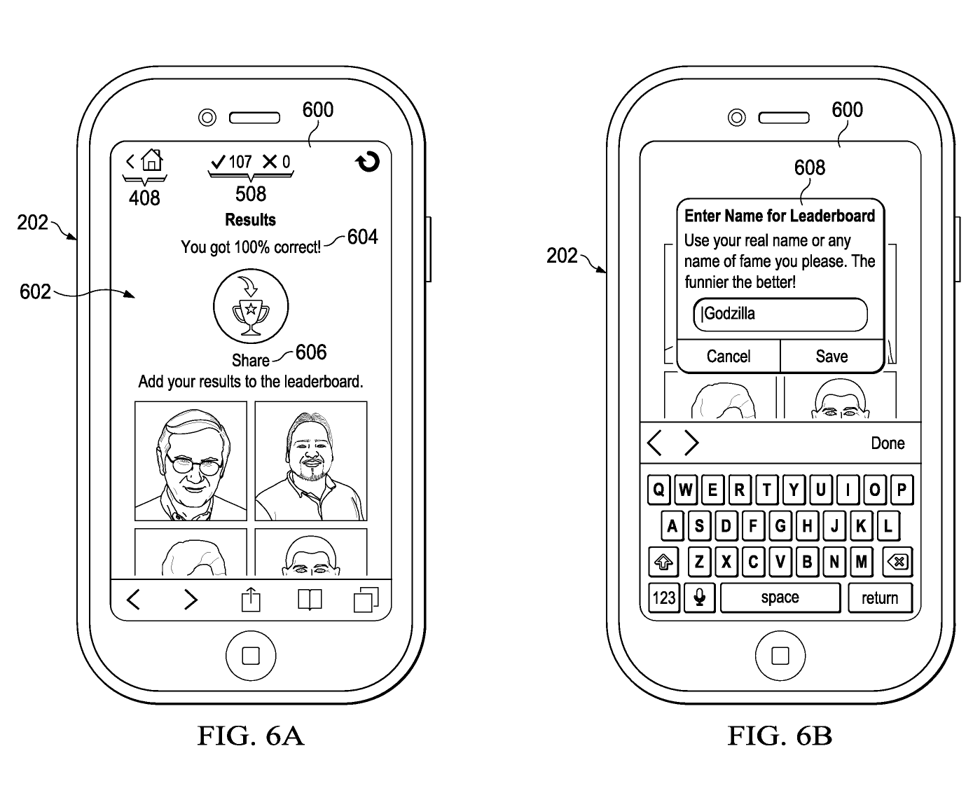

With reference now to FIGS. 6A and 6B, an illustration of a graphical user interface for providing feedback regarding response to multiple flashcards in a flashcard system is depicted in accordance with an illustrative embodiment. As depicted, graphical user interface 600 displays results 602 after a user completes a flashcards session.

Result 602 is an example of results that can be displayed in display system 124 of FIG. 1 by Scoring and Rewards module 112 of FIG. 1. As depicted, results 602 includes tally 508, score 604, and share icon 606. Score 604 is an indication of the relative performance of user for the current flashcards session. According to an illustrative embodiment, score 604 can be ratio of a number of correct responses to a total number of flashcards presented in the flashcards session.

Referring specifically to FIG. 6A, result 602 includes with share icon 606. Share icon 606 is a graphical image displayed on within graphical user interface 600 that enables a user to publish score 604 to a Scoring and Rewards module, such as Scoring and Rewards module 112 of FIG. 1. Scoring and Rewards module 112 may track the performance of individual users as well as tracking the performance of groups of individual users. Overall performance of individuals may be tracked. Overall success rate with certain flashcards or groups of flashcards may be tracked. Successful performance such as by answering a number of flashcards correctly may be associated with rewards for individuals, groups of individuals, and the like. The reward may be an accumulation of points, cash reward, public acknowledgment on a leaderboard, and the like. As depicted, share icon 606 permits Scoring and Rewards module 112 to publish score 604 to leaderboard 702, described in FIG. 7 below.

Referring now to FIG. 6B, pop-up 608 is shown within graphical user interface 600. According to an illustrative embodiment, graphical user interface 600 displays pop-up 608 in response to a selection of share icon 606. Pop-up 608 allows the user to enter a name, pseudonym, or other identifier, to be displayed in a leaderboard, such as leaderboard 702 described in FIG. 7 below.

Referring now to FIG. 7, an illustration of a graphical user interface for displaying overall performance of individuals in this a flashcard system is depicted in accordance with an illustrative embodiment. As depicted, graphical user interface 700 is graphical user interface 200 of FIG. 2 after a selection of icon 210 of FIG. 2.

Graphical user interface 700 displays leaderboard 702. Leaderboard 702 is a graphic within graphical user interface 700 that displays a relative performance of individual users, including a current ranking of users for a particular one of data sets 116 or relevant attributes 119.

As depicted, leaderboard 702 includes menu 704. Menu 704 is a graphical control element, that allows the user to select a particular one of data sets 116 of FIG. 1 or relevant attributes 119 of FIG. 1. The selection within the menu 704, scoring rewards module 112 of FIG. 1 filters leaderboard 702 to display current ranking 706 of users for the data set from menu 704. While menu 704 is depicted as a drop-down menu, menu 704 can include other graphical control elements that allow for user selection, such as but not limited to, or at least one of a button, a slider, a list box, a spinner, a drop-down menu, a menubar, a toolbar, a scrollbar and an icon.

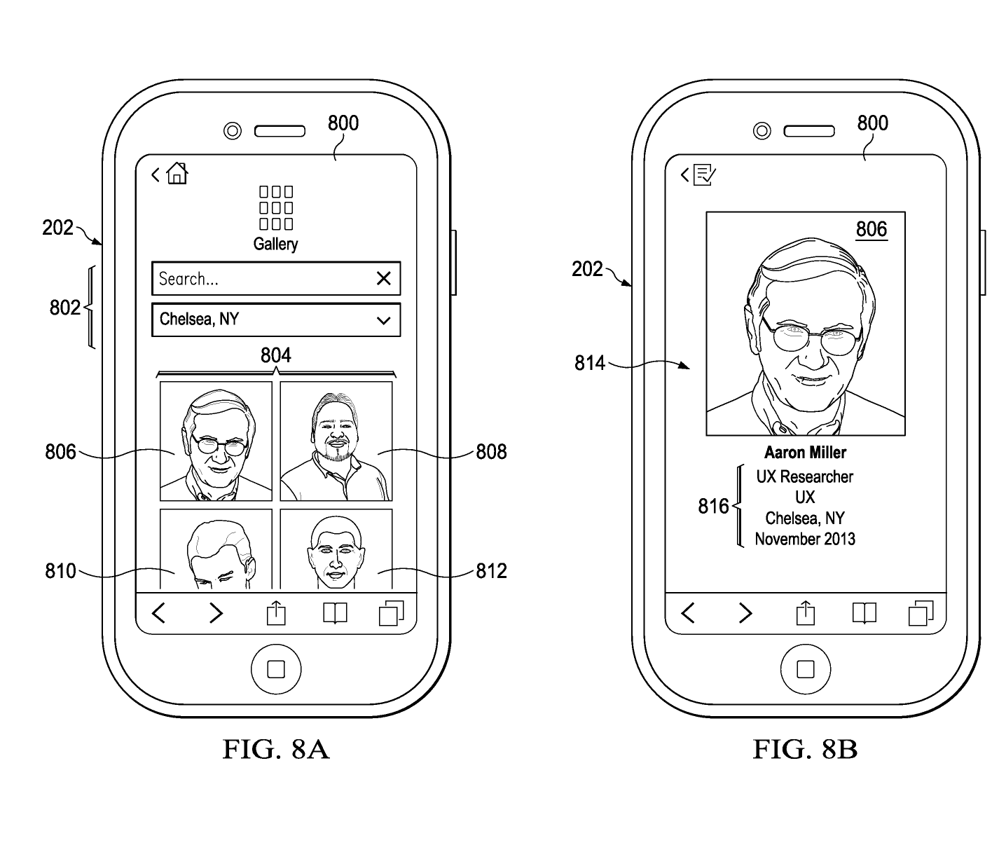

With reference next to FIGS. 8A and 8B, an illustration of a graphical user interface for selecting data sets and relevant attributes for review in this a flashcard system is depicted in accordance with an illustrative embodiment. As depicted, graphical user interface 800 is graphical user interface 200 of FIG. 2 after a selection of icon 212.

Referring specifically to FIGS. 8A and 8B, Graphical user interface 800 includes menus 802 for specifying a particular one of data sets 116 of FIG. 1 or relevant attributes 119 of FIG. 1 to be used by flashcards generator 122 of FIG. 1 when generating flashcards 106 of FIG. 1. By selecting a particular data set from menu 802, a user can review flashcards 106, including any employees and relevant attributes thereof. Flashcards generator 122 generates flashcards 106 from the selected one of data sets 116. Any relevant attributes 119 presented in flashcards 106 therefore relate only to the selected one of data sets 116, and not to the plurality of data sets 116 generally.

As depicted, menus 802 can further allow to select ones of relevant attributes 119 in order to further limit the generation and presentation of flashcards 106. By selecting particular relevant attributes from menus 802, a user can review flashcards 106, including any employees and relevant attributes thereof that are associated with the selected one of start dates 312 of FIG. 3C. Flashcards generator 122 generates flashcards 106 from the selected one of data sets 116 as limited by the selected ones of relevant attributes 119. Flashcards 106 generated by flashcard module 110 review therefore relate only to the selected ones of relevant attributes 119, and not generally to the plurality of relevant attributes 119 shown in menus 802.

As depicted, graphical user interface 800 includes gallery 804. Gallery 804 displays relevant attributes 806, 808, 810, and 812, as filtered by user selections of data sets 116 and relevant attributes 119 from menus 802. Each of relevant attributes 806, 808, 810, and 812 can be a relevant attributes such as one of relevant attributes 119 in FIG. 1. In response to selection of one of relevant attributes 806, 808, 810, and 812, graphical user interface 800 and displays flashcard 814 of FIG. 8B.

As depicted, relevant attributes 806, 808, 810, and 812 are images of different people. However, according to an illustrative embodiment, gallery 804 can display any of relevant attributes 119 to facilitate rapid learning. Therefore, while not shown, gallery 804 can include images, such as images of people, products, locations, flora and fauna. Prompted attribute 404 may include demographic or personal information such as an image of a person, the name, title, interest, family and friends, related projects, locations, start date for the company, associates and colleagues, skills, accomplishments and the like. Gallery 804 may display relevant attributes that include detailed information on a company's products and services such as images, specifications, applications, target markets, sales data, competitors, market data and the like. Gallery 804 may display relevant attributes that include information about any branch of learning from art history to geography and white. Gallery 804 may display relevant attributes that include timelines, geographic details, and the like. Gallery 804 may display relevant attributes that have in different temporal components were some of the data has little or no variability, such as a person's birthday, education, and other data is transitory such as a person's latest social media comments, current projects, and the like. Gallery 804 may display relevant attributes that have some location sensitive data over location information and people may be weighted more strongly in the selection flashcards.

Referring now to FIG. 8B, graphical user interface displays flashcard 814 in response to a selection of a relevant attributes from gallery 804 of FIG. 8A. As depicted, graphical user interface 800 displays flashcard 814 in response to a selection of relevant attribute 806 from gallery 804.

As depicted, flashcard 814 presents relevant attribute 806 and additional attributes 816. Flashcard 814 therefore provides the user the visual association of relevant attribute 806 with additional attributes 816 to facilitate rapid learning of both relevant attribute 806 and additional attributes 816.

As depicted, additional attributes 816 indicate a name, position, department, and location of a person. However, according to an illustrative embodiment, additional attributes 816 can be any of relevant attributes 119 to facilitate rapid learning. Therefore, while not shown, additional attributes 816 can be any of relevant attributes 119 and take any of the embodiments described above with relation to relevant attributes 119.

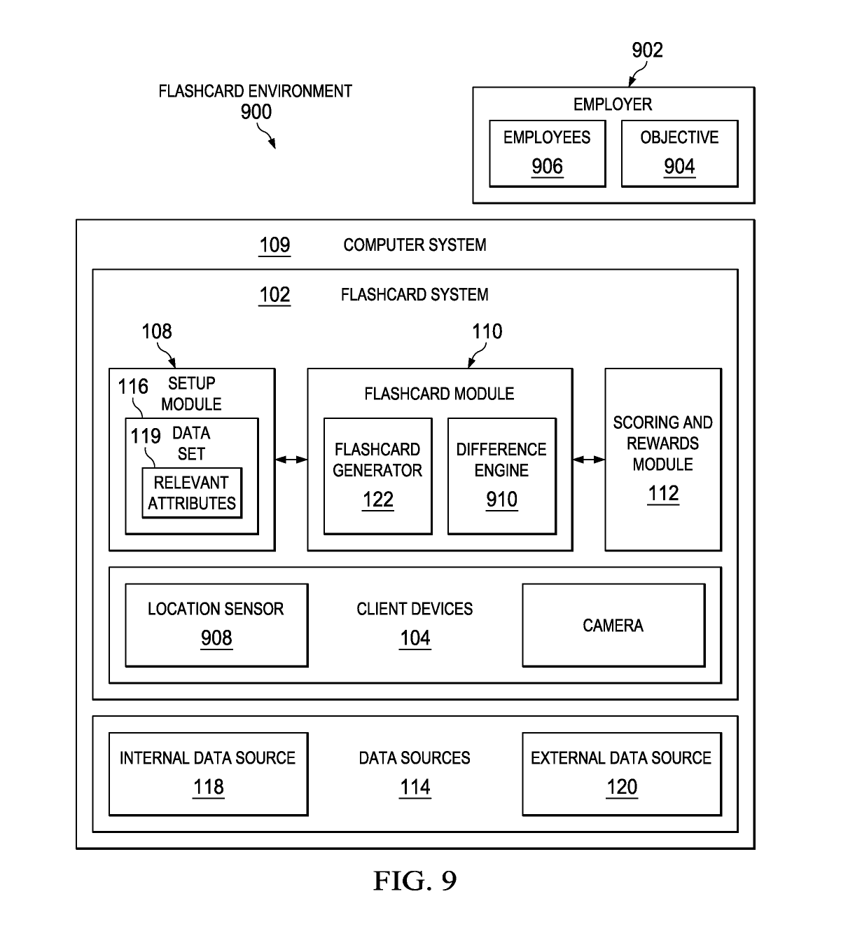

With reference now to FIG. 9, an illustration of a block diagram of a modified flashcard environment to facilitate the attainment of a specific business objective is depicted in accordance with an illustrative embodiment. Flashcard environment 900 includes flashcard system 102. Flashcard system 102 is modified to facilitate employer 902 in obtaining objectives 904.

Flashcard system 102 is used to perform operations with respect to employees 906 to facilitate employer 902 in obtaining objectives 904. The operations can be, for example but not limited to, at least one of training, monitoring, evaluating, and socializing activities to be performed by employees 906. As depicted, employees 906 are people who are employed by or associated with an entity for which flashcard system 102 is implemented, such as employer 902.

Objectives 904 are a set of one or more specific results that employer 902 aims to achieve by utilizing flashcard system 102. In an illustrative embodiment, flashcard system 102 may generate a flashcards 106 to achieve objectives 904 of preparing employees 906 for a particular meeting, conference or event. To achieve this objective, employer 902 may specify a particular data set 116 including relevant attributes 119 for use by flashcards generator 122 in preparing flashcards 106. To achieve this objective, a particular data set 116 including relevant attributes 119 is selected such as to facilitate rapid learning by employees 906 of relevant attributes 119 about other attendees of the meeting, conference, or event.

In an illustrative embodiment, client device 104 can include location sensor 908. Location sensor 908 is a sensor, such as a global positioning sensor, for determining a location of client devices 104. To achieve objectives 904 of preparing employees 906 for a particular meeting, conference or event, flashcards generator 122 can prepare flashcards 106 in response to environmental triggers or contextual triggers as indicated by location sensor 908. For example, flashcards generator 122 may generate flashcards 106 for employee 906 based on a determination of the location of employees 906 in relation to other attendees. flashcards generator 122 may generate flashcards 106 emphasizing relevant attributes 119 of those attendees who are in close proximity to the employee 906 as determined by location sensor 908 of client devices 104.

Business-centric networking facilitated by objectives 904 of preparing employees 906 for a particular meeting, conference or event relies on flashcard system 102 to be able to adapt relevant attributes 119 to be presented to the employees 906 in flashcards 106 based on environmental context such as who is in their immediate proximity. It is critical that these changes occur within a couple of seconds so that the user has access to the information most pertinent to the user's environmental context. By making information available on attendees in immediate proximity of employees 906, flashcard system 102 facilitates the achievement of objectives 904 by providing the user with information on those persons, common interests, mutual connections and the like and facilitates engagement with those one or more persons.

In an illustrative embodiment, flashcard system 102 may generate a flashcards 106 to achieve objectives 904 of facilitating a business-centric networking connection between employees 906 and a particular named attendee of a meeting, conference or event. According to an illustrative embodiment, flashcard module 110 can include difference engine 910. To facilitate the achievement of objectives 904, difference engine 910 may identify a path between relevant attributes 119 displayed on two separate flashcards 106. Based on relationship chain linking relevant attributes 119 of employees 906 to the named individual, difference engine 910 develops a series of potential paths or links between employees 906 to the named individual. Flashcards generator 122 can then generate flashcards 106 to steps for transition an employee 906 through the path of relevant links or states.

In an illustrative and non-limiting example, employee 906 might identify someone that they wish to meet at a conference. Difference engine 910 may identify a series of common contacts between the individual and that person, representing various potential paths to an introduction to that individual. Flashcards generator 122 can then develop a set of flashcards 106 to help employee 906 learn about the various common connections and how employee 906 might be able to network through those connections to arrange a meeting with the desired contact. Flashcards 106 might provide relevant attributes 119 of the different contacts, highlighting relevant attributes 119, and to employee 906 and the various common connections to make the networking smoother and more effective.

In an illustrative embodiment, flashcard system 102 may generate a flashcards 106 to achieve objectives 904 of training employees 906. According to an illustrative embodiment in a retail environment, flashcards generator 122 may generate flashcards 106 to familiarize employees 906 with relevant attributes 119 about regular clients of employer 902. Relevant attributes 119 can therefore include attributes such as a picture of the client's face, the client's name, the client's purchase history, the client's typical order, the client's payment information, the client's interests and the like. A certain level of proficiency with regard to relevant attributes 119 related to the client, or a particular score or ranking as indicated by Scoring and Rewards module 112 may be required as part of a training program for employees 906 with certain proficiency goals required to work certain shifts, positions, or accounts.

In an illustrative embodiment, flashcard system 102 may generate a flashcards 106 to achieve objectives 904 of training employees 906. According to an illustrative embodiment, the employees 906 may use the flashcards to facilitate rapid learning of products and services offered by the employer 902. Additionally, employees 906 may use the flashcards to facilitate rapid learning of a competitor's products, a competitor's services, and a competitor's clients. This in depth knowledge may establish a higher level of confidence in the sales clients leading to higher sales. A certain level of proficiency with regard to relevant attributes 119 related to the client, or a particular score or ranking as indicated by Scoring and Rewards module 112, may be used to determine who will call on a particular client or work on a particular project.

In an illustrative embodiment, flashcard system 102 may generate a flashcards 106 to achieve objectives 904 of training officer or agent, which can be employees 906. According to an illustrative embodiment in a law-enforcement environment, flashcards generator 122 may generate flashcards 106 using relevant attributes 119 regarding a terrain and people they are likely to encounter, such as suspects or threats. Employees 916 use flashcards 106 to rapidly learn relevant attributes 119. Information obtained from Scoring and Rewards module 112 may be used to drive policy decisions.

In an illustrative embodiment, flashcard system 102 may generate a flashcards 106 to achieve objectives 904 of facilitating team building and interaction among employees 906. Setup module 108 may build data sets 116 from internal data sources 118. As depicted, internal data sources 118 can include at least one of employee data for employees 906, organizational charts of employer 902, product resourcing information of employer 902, project resourcing information of employer 902, information on skills of employees 906, capabilities of employees 906, and communication density between employees 906. Flashcards generator 122 can generate flashcards 106 that emphasize relevant attributes 119. The illustrative, the relevant attributes can include at least one of attributes regarding people in upcoming meetings, attributes regarding people from an e-mail correspondence, and attributes regarding people with similar or complementary skill sets. Flashcards generator 122 can generate flashcards 106 to facilitate rapid learning by one of employees 906 of relevant attributes 119 of regarding others of employees 906. Scoring and Rewards module 112 would then facilitate competitions between individual ones of employees 906 or groups of employees 906 based on a relative performance for flashcards 106 regarding relevant attributes 119 of employees 906.

In an illustrative embodiment, flashcard system 102 may generate a flashcards 106 to achieve objectives 904 of identifying systemic knowledge gaps among employees 906. Scoring and Rewards module 112 may analyze performance of individual ones of employees 906 to determine progress in the rapid learning of relevant attributes 119 presented in flashcards 106. Scoring and Rewards module 112 may collate performance of employees 906 to aggregately analyze performance of employees 906 in the rapid learning of relevant attributes 119 presented in flashcards 106. Flashcard system 102 to make and use the aggregate analysis to identify systemic knowledge gaps in relevant attributes 119 among employees 906. Systemic knowledge gaps can be identified, for example, a threshold number of employees 906 performing poorly on flashcards 106 for a particular one of relevant attributes 119.

In an illustrative embodiment, flashcard system 102 may generate a flashcards 106 to achieve objectives 904 of evaluating employees 906. Employer 902 can utilize collated data of the aggregate performance of employees 906 provided by scoring rewards module 112 as one vector for analysis when benchmarking performance of individual or groups of employees 906 relative to the performance of other individual or groups of employees 906. In an illustrative embodiment, employer 902 can utilize the collated data to measure performance of employees 906 relative to a regional or nationwide index of other groups of employees 906. The index can be, for example, an index restricted to groups of employees 906 having similar sizes. In an illustrative embodiment, employer 902 can utilize the collated data to measure performance of employees 906 relative to a regional or nationwide index of other employers. The index can be, for example, an index restricted to organizations of similar sizes to employer 902.

In an illustrative embodiment, flashcard system 102 may generate a flashcards 106 to achieve objectives 904 of improving performance of employer 902. Performance of employees 906 on flashcards 106 with regard to relevant attributes 119 for others of about employees 906, as measured by Scoring and Rewards module 112, may be used as benchmarks for comparisons between employer 902 and other organizations. According to an illustrative embodiment, flashcard system 102 can define a metric each of employees 906 knows others of employees 906. This metric may be calculated based on performance of employees 906 on flashcards 106 with regard to relevant attributes 119 for others of about employees 906, as measured by Scoring and Rewards module 112. Employer 902 may use information provided by the metric to benchmark performance of employer 902 relative to similar organizations. In this manner, flashcard system 102 facilitates a determination by employer 902 of an optimal level of knowledge and interaction among employees 906 based on performance of employer 902 relative to similar organizations.

With reference next to FIG. 10, an illustration of a flowchart of a process for generating the set of flashcards is shown according to an illustrative embodiment. Process 1000 may be implemented in flashcards generator 122 in flashcard system 102 of the flashcard environment 100 of FIG. 1.

Process 1000 begins by receiving a request from a client device to begin a flashcards session (step 1002). The client device can be, for example one client device 104 of FIG. 1. The request can be generated through interaction with graphical user interface 126 of client device 104, such as an interaction of one of icons 206, 208, or 212 of FIG. 2.

Process 1000 next receives the selection of a data set from the client device (step 1004). The data set in the one data sets 116 in FIG. 1. The selection can be generated through interaction with graphical user interface 126 of client device 104. As depicted, the interaction can be an interaction with menu 302 of graphical user interface 300.

Process 1000 next receives a selection of at least one relevant attribute from the client device (step 1006). The relevant attribute can be one or more of relevant attributes 119 of FIG. 1. The selection can be generated through interaction with graphical user interface 126 of client device 104. As depicted, the interaction can be an interaction with at least one of cycle menu 310 and cycle menu 314 of graphical user interface 300.

Process 1000 generates flashcards from the selected data set based on the one or more selected relevant attributes (step 1008). The flashcards can be one or more of flashcards 106 in FIG. 1. Process 1000 restricts generation of flashcards 106 based on the selected data and selected relevant attributes. Therefore, process 1000 generates flashcards 106 from only the selected one of data sets 116 as limited by the selected ones of relevant attributes 119. Any relevant attributes 119 presented in flashcards 106 therefore relate only to the selected data set and the selected element attributes. The generated flashcards can include a prompted attribute, such as prompted attribute 404 of FIG. 4, and one or more attribute responses, such as attribute responses 406 in FIG. 4.

Process 1000 sends the generated flashcards to the client device in a predefined sequence (step 1010), with the process terminating thereafter. The predefined sequence can be a progression of flashcards 106 that logically progresses through a particular the selected relevant attributes of the selected data set to facilitate rapid learning of the selected data set.

With reference next to FIG. 11, an illustration of a flowchart of a process for evaluating user performance for the flashcards as shown according to an illustrative embodiment. Process 1100 may be implemented in Scoring and Rewards module 112 in flashcard system 102 of the flashcard environment 100 of FIG. 1.

Process 1100 begins by receiving a request to publish results to a leaderboard (step 1102). The results are an example of results that can be displayed in display system 124 by Scoring and Rewards module 112 of FIG. 1. The results can be for example, results 602 of FIG. 6. The request can be generated through interaction with graphical user interface 126 of client device 104, such as an interaction with share icon 606 of FIG. 6.

Process 1100 receives results (step 1104). The results can include a tally, such as tally 508, and a score, such a score 604, for selected data set.

Process 1100 then publishes the results to a leaderboard (step 1106), with the process terminating thereafter. The leaderboard can be, for example leaderboard 702 of FIG. 7. The leaderboard can be filtered to displays a relative performance of individual users, including a current ranking of users for a particular one of data sets 116 or relevant attributes 119. An employer, such as employer 902 of FIG. 9, can use the results published to the leaderboard to drive policy decisions to facilitate achieving one or more objectives, such as objectives 904 of FIG. 9.

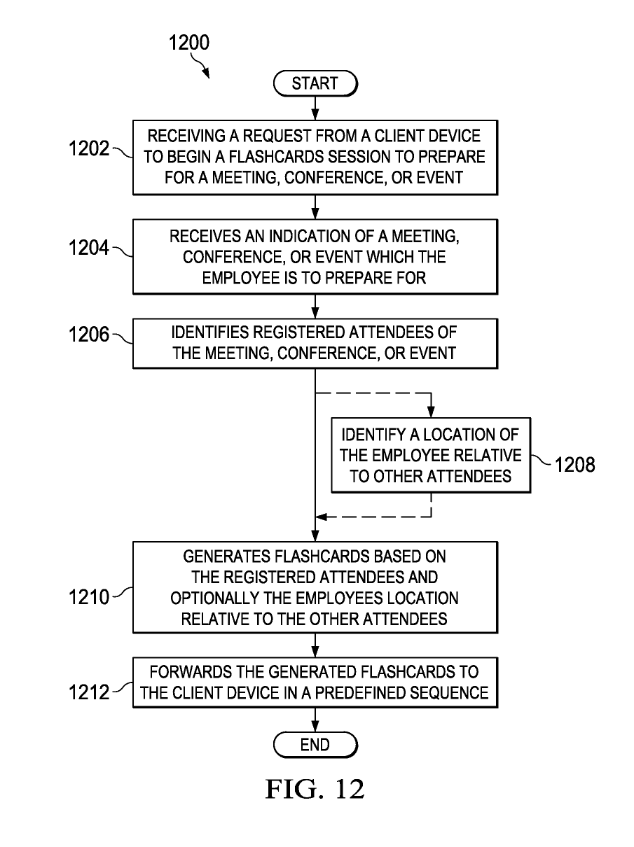

With reference next to FIG. 12, an illustration of a flowchart of a process for generating a set of flashcards for achieving an objective of preparing employees for a meeting, conference or event is shown according to an illustrative embodiment. Process 1200 may be implemented in flashcards generator 122 in flashcard system 102 of the flashcard environment 900 of FIG. 9.

Process 1200 begins by receiving a request from a client device to begin a flashcards session to prepare for a meeting, conference, or event (step 1202). The client device can be, for example one client device 104 of FIG. 1. The request can be generated through interaction with graphical user interface 126 of client device 104, such as an interaction of one of icons 206, 208, or 212 of FIG. 2.

Process 1200 next receives an indication of a meeting, conference, or event which the employee is to prepare for (step 1204). The indication can be provided by employer 902 of FIG. 9. Indication can be for a particular data set corresponding to the meeting, conference, or event. The data set can be one of data sets 116 in FIG. 9.

Process 1200 next identifies registered attendees of the meeting, conference, or event (step 1206). The registered attendees can be a relevant attribute for the data set corresponding to the meeting, conference, or event. The registered attendees can therefore be one or more of relevant attributes 119 of FIG. 9.

Process 1200 can optionally identify a location of the employee relative to other attendees (step 1208). The location can be provided by location sensor 908 in client device 104 of FIG. 9.

Process 1200 generates flashcards based on the registered attendees and optionally the employees location relative to the other attendees (step 1210). The flashcards can be one or more of flashcards 106 in FIG. 1. Process 1200 restricts generation of flashcards 106 based on the selected data set corresponding to the meeting, conference, or event, and selected relevant attributes corresponding to the registered attendees. Therefore, process 1200 generates flashcards 106 from only the registered attendees for the conference, meeting, or event. Any relevant attributes 119 presented in flashcards 106 therefore relate only to the registered attendees. The generated flashcards can include a prompted attribute, such as prompted attribute 404 of FIG. 4, and one or more attribute responses, such as attribute responses 406 in FIG. 4.

Process 1200 forwords the generated flashcards to the client device in a predefined sequence (step 1212), with the process terminating thereafter. The predefined sequence can be a progression of flashcards 106 that logically progresses through a particular the selected relevant attributes of the selected data set to facilitate rapid learning of the selected data set. The predefined sequence may be based on the identified location of the employee relative to other attendees, to emphasize those attendees who are in close proximity to the employee.

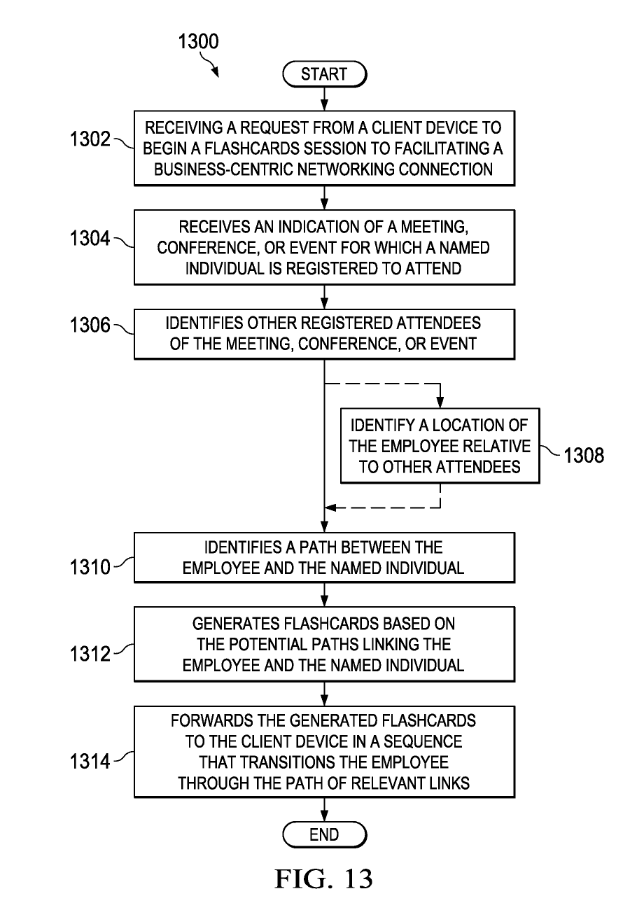

With reference next to FIG. 13, an illustration of a flowchart of a process for generating a set of flashcards for achieving an objective of facilitating a business-centric networking connection for an employee is shown according to an illustrative embodiment. Process 1300 may be implemented in flashcards generator 122 in flashcard system 102 of the flashcard environment 900 of FIG. 9.

Process 1300 begins by receiving a request from a client device to begin a flashcards session to facilitating a business-centric networking connection (step 1302). The client device can be, for example one client device 104 of FIG. 1. The request can be generated through interaction with graphical user interface 126 of client device 104, such as an interaction of one of icons 206, 208, or 212 of FIG. 2.

Process 1300 next receives an indication of a meeting, conference, or event for which a named individual is registered to attend (step 1304). The named individual is the desired business-centric networking connection. The indication can be provided by employer 902 of FIG. 9. Alternatively, The selection can be generated through interaction with graphical user interface 126 of client device 104. The indication can be for a particular data set corresponding to the meeting, conference, or event. The data set can be one of data sets 116 in FIG. 9.

Process 1300 next identifies other registered attendees of the meeting, conference, or event (step 1306). The registered attendees can be a relevant attribute for the data set corresponding to the meeting, conference, or event. The registered attendees can therefore be one or more of relevant attributes 119 of FIG. 9.

Process 1300 can optionally identify a location of the employee relative to other attendees (step 1308). The location can be provided by location sensor 908 in client device 104 of FIG. 9.

Process 1300 then identifies a path between the employee and the named individual (step 1310). The path can be identified utilizing a difference engine, such as difference engine 910 of FIG. 9. To facilitate the business-centric networking connection, process 1300 may develop a series of potential paths for links between the employee and the named individual, based on relationship chain linking relevant attributes of the employee to relevant attributes of other attendees, and finally to relevant attributes of the named individual.

Process 1300 generates flashcards based on the potential paths linking the employee and the named individual (step 1312). The flashcards can be one or more of flashcards 106 in FIG. 1. Process 1300 restricts generation of flashcards 106 based on the selected data set corresponding to the meeting, conference, or event, and selected relevant attributes corresponding to the registered attendees. Therefore, process 1300 generates flashcards 106 from only the registered attendees for the conference, meeting, or event. Any relevant attributes 119 presented in flashcards 106 therefore relate only to the registered attendees. The generated flashcards can include a prompted attribute, such as prompted attribute 404 of FIG. 4, and one or more attribute responses, such as attribute responses 406 in FIG. 9.

Process 1300 forwords the generated flashcards to the client device in a sequence that transitions the employee through the path of relevant links (step 1314), with the process terminating thereafter. The sequence can be a progression of flashcards 106 that logically progresses through the path of relevant links to facilitate the desired business-centric networking connection for the employee. The predefined sequence may be based on the identified location of the employee relative to other attendees, to emphasize attendees identified in the potential paths who are in close proximity to the employee.

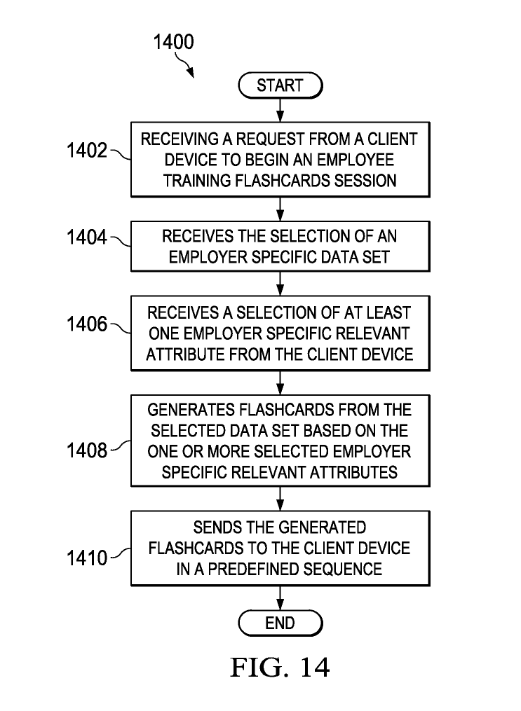

With reference next to FIG. 14, an illustration of a flowchart of a process for generating the set of flashcards for achieving an objective of training employees within a retail environment is shown according to an illustrative embodiment. Process 1400 may be implemented in flashcards generator 122 in flashcard system 102 of the flashcard environment 100 of FIG. 1.

Process 1400 and begins by receiving a request from a client device to begin an employee training flashcards session (step 1402). The client device can be, for example one client device 104 of FIG. 1. The request can be generated through interaction with graphical user interface 126 of client device 104, such as an interaction of one of icons 206, 208, or 212 of FIG. 2.

Process 1400 next receives the selection of an employer specific data set (step 1404). The employer specific data set in the one data sets 116 in FIG. 1. The employer specific data set can be related to at least one of regular clients of the employer, products and services offered by the employer, and products and services offered by a competitor of the employer. The selection can be generated through interaction with graphical user interface 126 of client device 104. As depicted, the interaction can be an interaction with menu 302 of graphical user interface 300 of FIG. 3.

Process 1400 next receives a selection of at least one employer specific relevant attribute from the client device (step 1406). The employer specific relevant attributes can include attributes related to a client, such as at least one of a picture of the client's face, the client's name, the client's purchase history, the client's typical order, the client's payment information, the client's interests. The employer specific relevant attributes can include attributes related to products and services, such as at least one of products provided by the employer, services provided by the employer, products provided by a competitor of the employer, and services provided by a competitor of the employer. The relevant attribute can be one or more of relevant attributes 119 of FIG. 1. The selection can be generated through interaction with graphical user interface 126 of client device 104. As depicted, the interaction can be an interaction with at least one of cycle menu 310 and cycle menu 314 of graphical user interface 300 of FIG. 9.

Process 1400 generates flashcards from the selected data set based on the one or more selected employer specific relevant attributes (step 1408). The flashcards can be one or more of flashcards 106 in FIG. 1. Process 1400 restricts generation of flashcards 106 based on the selected data and selected relevant attributes. Therefore, process 1400 generates flashcards 106 from only the selected one of data sets 116 as limited by the selected ones of relevant attributes 119. Any relevant attributes 119 presented in flashcards 106 therefore relate only to the selected data set and the selected element attributes. The generated flashcards can include a prompted attribute, such as prompted attribute 404 of FIG. 4, and one or more attribute responses, such as attribute responses 406 in FIG. 4.

Process 1400 sends the generated flashcards to the client device in a predefined sequence (step 1410), with the process terminating thereafter. The predefined sequence can be a progression of flashcards 106 that logically progresses through a particular the selected relevant attributes of the selected data set to facilitate rapid learning of the selected data set.

A certain level of proficiency with regard to relevant attributes 119 related to the client, or a particular score or ranking as indicated by Scoring and Rewards module 112 may be required as part of a training program for employees 906 with certain proficiency goals required to work certain shifts, positions, or accounts. Additionally, A certain level of proficiency with regard to relevant attributes 119 related to the client, or a particular score or ranking as indicated by Scoring and Rewards module 112, may be used to determine who will call on a particular client or work on a particular project.

With reference next to FIG. 15, an illustration of a flowchart of a process for generating the set of flashcards for achieving the objectives of training employees within a law-enforcement environment is shown according to an illustrative embodiment. Process 1500 may be implemented in flashcards generator 122 in flashcard system 102 of the flashcardflashcard environment 100 of FIG. 1.

Process 1500 begins by receiving a request from a client device to begin an employee training flashcards session (step 1502). The client device can be, for example one client device 104 of FIG. 1. The request can be generated through interaction with graphical user interface 126 of client device 104, such as an interaction of one of icons 206, 208, or 212 of FIG. 2.

Process 1500 next receives the selection of a patrol area from the client device (step 1504). The patrol area can be, for example at least one of a county, city, metropolitan area, precinct, neighborhood, a city block, or other geographical location to which that law enforcement employee can be assigned. The patrol area is a data set, such as one of data sets 116 in FIG. 1. The selection can be generated through interaction with graphical user interface 126 of client device 104. As depicted, the interaction can be an interaction with menu 302 of graphical user interface 300 of FIG. 3.

Process 1500 next receives a selection of at least one relevant attribute of the patrol area from the client device (step 1506). Relevant attributes of the patrol area can include, but are not limited to at least one of a terrain of the patrol area, people that the law enforcement employee is likely to encounter in the patrol area, known suspects that the law enforcement employee is likely to encounter in the patrol area, and known threats that the law enforcement employee is likely to encounter in the patrol area. The relevant attribute can be one or more of relevant attributes 119 of FIG. 1. The selection can be generated through interaction with graphical user interface 126 of client device 104 of FIG. 1. As depicted, the interaction can be an interaction with at least one of cycle menu 310 and cycle menu 314 of graphical user interface 300 of FIG. 3.

Process 1500 generates flashcards from the selected data set based on the selected relevant attributes of the patrol area (step 1508). The flashcards can be one or more of flashcards 106 in FIG. 1. Process 1500 restricts generation of flashcards 106 based on the selected data and selected relevant attributes. Therefore, process 1500 generates flashcards 106 from only the selected one of data sets 116 as limited by the selected ones of relevant attributes 119. Any relevant attributes 119 presented in flashcards 106 therefore relate only to the patrol area and the relevant attributes of the patrol area. The generated flashcards can include a prompted attribute, such as prompted attribute 404 of FIG. 4, and one or more attribute responses, such as attribute responses 406 in FIG. 4.

Process 1500 sends the generated flashcards to the client device in a predefined sequence (step 1510), with the process terminating thereafter. The predefined sequence can be a progression of flashcards 106 that logically progresses through the selected relevant attributes of the patrol area to facilitate rapid learning of patrol area and the relevant attributes of the patrol area.

Employer 902 can utilize information obtained from Scoring and Rewards module 112 to drive policy decisions. For example, employer 902 may use scores or rankings as indicated by Scoring and Rewards module 112, may be used to determine which of employees 906 will be assigned to a particular patrol area, a particular investigation, or a particular department.

In this manner, the training, monitoring, evaluating, and socializing activities of employees can be made more easily as compared to currently used techniques. The disclosed flashcard system generates and presents flashcards based on predefined sequence. The predefined sequence logically progresses through a particular topic to facilitate rapid learning of the topic. As a result, employees can more quickly learn and retain information regarding the topic. Furthermore, by training, monitoring, evaluating activities to be performed by employees as part of the flashcards system, a desired level of knowledge and proficiency among employees is enabled. These and other tasks may be performed using the visualization of generated flashcards that are manipulated to interact within a graphical user interface to generate a result. As result, an employee may more efficiently learn and retain information based on the visualization of the flashcards in a graphical user interface.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the Figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

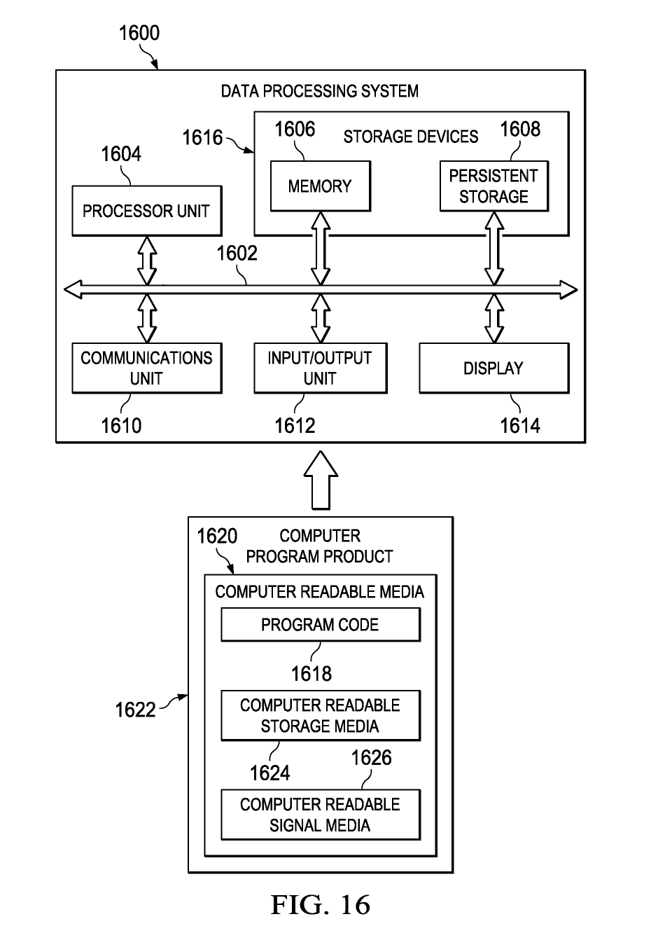

Turning now to FIG. 16, an illustration of a block diagram of a data processing system is depicted in accordance with an illustrative embodiment. Data processing system 1600 may be used to implement one or more data processing systems in flashcard system 102 in FIG. 1. In this illustrative example, data processing system 1600 includes communications framework 1602, which provides communications between processor unit 1604, memory 1606, persistent storage 1608, communications unit 1610, input/output unit 1612, and display 1614. In this example, communication framework may take the form of a bus system.

Processor unit 1604 serves to execute instructions for software that may be loaded into memory 1606. Processor unit 1604 may be a number of processors, a multi-processor core, or some other type of processor, depending on the particular implementation.

Memory 1606 and persistent storage 1608 are examples of storage devices 1616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1616 may also be referred to as computer readable storage devices in these illustrative examples. Memory 1606, in these examples, may be, for example, a random access memory or any other suitable volatile or non-volatile storage device. Persistent storage 1608 may take various forms, depending on the particular implementation.

For example, persistent storage 1608 may contain one or more components or devices. For example, persistent storage 1608 may be a hard drive, a flash memory, a rewritable optical disk, a rewritable magnetic tape, or some combination of the above. The media used by persistent storage 1608 also may be removable. For example, a removable hard drive may be used for persistent storage 1608.

Communications unit 1610, in these illustrative examples, provides for communications with other data processing systems or devices. In these illustrative examples, communications unit 1610 is a network interface card.

Input/output unit 1612 allows for input and output of data with other devices that may be connected to data processing system 1600. For example, input/output unit 1612 may provide a connection for user input through at least of a keyboard, a mouse, or some other suitable input device. Further, input/output unit 1612 may send output to a printer. Display 1614 provides a mechanism to display information to a user.

Instructions for at least one of the operating system, applications, or programs may be located in storage devices 1616, which are in communication with processor unit 1604 through communications framework 1602. The processes of the different embodiments may be performed by processor unit 1604 using computer-implemented instructions, which may be located in a memory, such as memory 1606.

These instructions are referred to as program code, computer usable program code, or computer readable program code that may be read and executed by a processor in processor unit 1604. The program code in the different embodiments may be embodied on different physical or computer readable storage media, such as memory 1606 or persistent storage 1608.

Program code 1618 is located in a functional form on computer readable media 1620 that is selectively removable and may be loaded onto or transferred to data processing system 1600 for execution by processor unit 1604. Program code 1618 and computer readable media 1620 form computer program product 1622 in these illustrative examples. In one example, computer readable media 1620 may be computer readable storage media 1624 or computer readable signal media 1626.

In these illustrative examples, computer readable storage media 1624 is a physical or tangible storage device used to store program code 1618 rather than a medium that propagates or transmits program code 1618.

Alternatively, program code 1618 may be transferred to data processing system 1600 using computer readable signal media 1626. Computer readable signal media 1626 may be, for example, a propagated data signal containing program code 1618. For example, computer readable signal media 1626 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1600 are not meant to provide architectural limitations to the manner in which different embodiments may be implemented. The different illustrative embodiments may be implemented in a data processing system including components in addition to or in place of those illustrated for data processing system 1600. Other components shown in FIG. 16 can be varied from the illustrative examples shown. The different embodiments may be implemented using any hardware device or system capable of running program code 1618.

Thus, the illustrative embodiments provide a method and apparatus for graphically displaying data within a flashcard system that facilitates a networking connection of an employee. In one example, a process for graphically displaying data within a flashcard system that facilitates networking connection of an employee is presented. A computer system identifies a meeting the employee is scheduled to attend. The computer system then identifies the social interest of the employee. Based on the social interest, the computer system identifies a contact for the employee who is also attending the meeting. The computer system generates a group of flashcards for relevant attributes about the contact. The relevant attributes about the contractor associated with the social interest. The computer system displays the group of flashcards for the relevant attributes about the contact. Displaying the group of flashcards about the social interest enables communication between the employee and the contact at the meeting, thereby facilitating the network connection between the employee and contact.

In this manner, presenting contextually relevant information in flashcard system can be made more easily as compared to currently used techniques. Because digital flashcards of the flashcard system are automatically updated to visually present new information for situationally relevant topics, making network connections within a business environment is facilitated for the employee. As a result, employee network connections are more easily made, and the business is better able to achieve relevant business goals based on the facilitated networking connections.

The description of the different illustrative embodiments has been presented for purposes of illustration and description, and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. In particular, evaluation auditor is configured to perform the different operations described as well as other operations using at least one of program code, hardware, firmware, or other suitable components.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for facilitating a networking connection of an employee, the method comprising:
identifying, by a computer system, a meeting the employee is scheduled to attend;
identifying, by a computer system, a social interest for the employee;
identifying, by the computer system, a contact attending the meeting based on the social interest;
generating, by the computer system, a group of flashcards for relevant attributes about the contact, wherein the relevant attributes about the contact are associated with the social interest, wherein displaying the a group of flashcards about the social interest enables communications between the employee and the contact at the meeting; and
displaying, by the computer system, the group of flashcards for the relevant attributes about the contact.

2. The method of claim 1 further comprising:
receiving, by the computer system, user input to questions presented on the group of flashcards; and
determining, by the computer system, whether the employee has retained the relevant attributes.

3. The method of claim 2, wherein the step of determining whether the employee has retained the relevant attributes further comprises:
determining whether the employee has achieved a certain proficiency goal for the relevant attributes based on the user input to questions presented on the group of flashcards.

4. The method of claim 1 further comprising:
receiving, by the computer system, user input identifying the social interest for the meeting.

5. The method of claim 4, wherein identifying the social interest further comprises:
comparing social interests of the employee and social interests of the contact to identify shared social interests between the employee and the contact.

6. The method of claim 1 wherein displaying the group of flashcards includes:
identifying changes to portions of the relevant attributes since a prior time the group of flashcards were generated;
generating the group of flashcards to include the identified changes; and
preferentially presenting flashcards from group of flashcards that include the identified changes.

7. The method of claim 1 further comprising:
identifying, by the computer system, an intermediate contact attending the meeting based on the social interest, wherein the intermediate contact forms a path linking the employee to the contact;
generating the group of flashcards for relevant attributes about the intermediate contact, wherein the relevant attributes about the contact are associated with the social interest, wherein displaying the a group of flashcards about the social interest enables communications between the employee and the contact at the meeting; and
displaying, by the computer system, the group of flashcards for the relevant attributes about the intermediate contact and for the relevant attributes about the contact, wherein the group of flashcards is displayed in a sequence that transitions the employee through the path linking the employee to the contact.

8. A computer system comprising:
a display system; and
a flashcard generator of a flash card system in the computer system in communication with the display system, wherein the flashcard generator identifies a meeting and employee scheduled to attend; identifies a social interest for the employee; identifies a contact attending the meeting based on the social interest; generates a group of flashcards for relevant attributes about the contact, wherein the relevant attributes about the contact are associated with the social interest, wherein displaying the group of flashcards about the social interest enables communications between the employee and contact at the meeting; and displaying the group of flashcards for the relevant attributes about the contact, wherein displaying the group of flashcards facilitates making a networking connection of the employee.

9. The computer system of claim 8, wherein the flashcard system receives user input to questions presented, group flashcards; and determines whether the employee has retained the relevant attributes.

10. The computer system of claim 9, wherein the step of determining whether the employee has retained the relevant attributes further comprises:
determining whether the employee has achieved a certain proficiency goal for the relevant attributes based on the user input to questions presented on the group of flashcards.

11. The computer system of claim 8, wherein the flashcard system receives user input identifying the social interest for the meeting.

12. The computer system of claim 11, wherein identifying the social interest further comprises:
comparing social interests of the employee and social interests of the contact to identify shared social interests between the employee and the contact.

13. The computer system of claim 8 wherein displaying the group of flashcards includes:
identifying changes to portions of the relevant attributes since a prior time the group of flashcards were generated;
generating the group of flashcards to include the identified changes; and
preferentially presenting flashcards from group of flashcards that include the identified changes.

14. The computer system of claim 8, wherein the flashcard system further comprises a setup module, wherein the setup module identifies an intermediate contact attending the meeting based on the social interest, wherein the intermediate contact forms a path linking the employee to the contact; and
wherein the flashcard generator generates the group of flashcards for relevant attributes about the intermediate contact, wherein the relevant attributes about the contact are associated with the social interest, wherein displaying the group of flashcards about the social interest enables communications between the employee and the contact at the meeting; displays the group of flashcards for the relevant attributes about the intermediate contact and for the relevant attributes about the contact, wherein the group of flashcards is displayed in a sequence that transitions the employee through the path linking the employee to the contact.

15. A computer program product for facilitating a networking connection of an employee, the computer program product comprising:
a computer readable storage media;
first program code, stored on the computer readable storage media, for identifying a meeting the employee is scheduled to attend;
second program code, stored on the computer readable storage media, for identifying a social interest for the employee;
third program code, stored on the computer readable storage media, for identifying a contact attending the meeting based on the social interest;
fourth program code, stored on the computer readable storage media, for generating a group of flashcards for relevant attributes about the contact, wherein the relevant attributes about the contact are associated with the social interest, wherein displaying the a group of flashcards about the social interest enables communications between the employee and the contact at the meeting; and
fifth program code, stored on the computer readable storage media, for displaying the group of flashcards for the relevant attributes about the contact.

16. The computer program product of claim 15 further comprising:
sixth program code, stored on the computer readable storage media, for receiving user input to questions presented on the group of flashcards; and
seventh program code, stored on the computer readable storage media, for determining whether the employee has retained the relevant attributes.

17. The computer program product of claim 16, wherein the seventh program code for determining whether the employee has retained the relevant attributes further comprises:
program code for determining whether the employee has achieved a certain proficiency goal for the relevant attributes based on the user input to questions presented on the group of flashcards.

18. The computer program product of claim 15 further comprising:
sixth program code, stored on the computer readable storage media, for receiving user input identifying the social interest for the meeting.

19. The computer program product of claim 18, wherein a second program code for identifying the social interest further comprises:
program code for comparing social interests of the employee and social interests of the contact to identify shared social interests between the employee and the contact.

20. The computer program product of claim 15 wherein the fifth program code for displaying the group of flashcards includes:
program code for identifying changes to portions of the relevant attributes since a prior time the group of flashcards were generated;
program code for generating the group of flashcards to include the identified changes; and
program code for preferentially presenting flashcards from group of flashcards that include the identified changes.

21. The computer program product of claim 15 further comprising:
sixth program code, stored on the computer readable storage media, for identifying an intermediate contact attending the meeting based on the social interest, wherein the intermediate contact forms a path linking the employee to the contact;
seventh program code, stored on the computer readable storage media, for generating the group of flashcards for relevant attributes about the intermediate contact, wherein the relevant attributes about the contact are associated with the social interest, wherein displaying the a group of flashcards about the social interest enables communications between the employee and the contact at the meeting; and
eighth program code, stored on the computer readable storage media, for displaying the group of flashcards for the relevant attributes about the intermediate contact and for the relevant attributes about the contact, wherein the group of flashcards is displayed in a sequence that transitions the employee through the path linking the employee to the contact.
